(19) United States
(12) Patent Application Publication
(10) Pub. No.: US 2015/0026333 A1
(43) Pub. Date: Jan. 22, 2015

(54) NETWORK SYSTEM, NETWORK MANAGEMENT APPARATUS AND APPLICATION MANAGEMENT APPARATUS

(71) Applicant: Hitachi, Ltd., Tokyo (JP)

(72) Inventors: Hiroyuki KUBO, Tokyo (JP); Takeshi SHIBATA, Tokyo (JP); Kiyotaka TAKAHASHI, Tokyo (JP); Masahiro KIMURA, Tokyo (JP)

(73) Assignee: Hitachi, Ltd., Tokyo (JP)

(21) Appl. No.: 14/332,760

(22) Filed: Jul. 16, 2014

(30) Foreign Application Priority Data
Jul. 19, 2013 (JP) 2013-150688

(51) Int. Cl. H04L 12/26

(52) U.S. Cl. CPC H04L 43/08
USPC 709/224

(57) ABSTRACT

A network management apparatus is configured to: receive transmitted information acquisition request; generate, based on topology storage area, an application edge device list indicating at least one edge network device through which the traffic for providing an application indicated by the information acquisition request passes; identify a route through which the traffic for providing the application indicated by the information acquisition request passes, based on the generated application edge device list and the provision source of the application indicated by the information acquisition request; acquire quality information on the identified route; and transmit the acquired quality information to the application management apparatus.

### CLAIM OF PRIORITY

The present application claims priority from Japanese patent application JP2013-150688 filed on Jul. 19, 2013, the content of which is hereby incorporated by reference into this application.

### BACKGROUND

In the following description, a process for transferring data from a transmitting-end client to a receiving-end client through a network and controlling the receiving-end client to execute predetermined processing based on the transferred data is defined as “application”. The client executes the predetermined processing by being provided with a function by the application. For example, a video distribution application transfers video data from the transmitting-end client holding the video data to the receiving-end client through the network, and controls the receiving-end client to display the received video data.

The function of the client differs depending on the provided application. The client has a function of, for example, a server for holding data or a client in accordance with the provided application.

In a case where an application provides the client with a function, when traffic flowing through the network increases, due to congestion or the like caused on a transfer route for the data, a transfer route from the transmitting-end client to the receiving-end client may fail to satisfy a bandwidth or an allowable delay time requested by the application. In this case, quality of providing the application is impaired.

Up to now, there is proposed a method of maintaining the quality of providing the application by dynamically switching a route for transferring data to a route for diverting the data around a congested route (see, for example, JP 2009-303090 A).

JP 2009-303090 A is realized by a network administrator controlling the network in accordance with a situation in which the application is provided. However, when the network is large in scale, the number of applications provided through the network is enormous, and hence it is unrealistic to subject each of the applications to network control such as dynamic switching of the route because of an increase in costs for the network administrator.

Further, there is proposed a method in which a client (transmitting client) transmitting data to a given client (receiving client) is switched to another transmitting client holding the same data as that of the transmitting client that has been transmitting the data, to thereby change a distribution route for data to the receiving client and enhance the quality of providing the application (see, for example, Haiyong Xie and three others, “P4P: Explicit Communications for Cooperative Control Between P2P and Network Providers”, [online], [retrieved on Jun. 27, 2013]).

In Haiyong, the changing of the distribution route based on the switching of the transmitting client is performed by a user of the application or an administrator of the application, and the changing on the network is unnecessary. Therefore, Haiyong's method can be realized even on a large-scale network providing an enormous number of applications.

However, whether or not the quality of providing the application is to be improved by changing the distribution route depends on network quality at that time point. Therefore, in a case of using Haiyong's method, a problem remains in a method of providing network quality information to the administrator of the application.

Further, even when the user or the administrator can ideally select a route, the bandwidth that can be used by the application on the route after the switching may be already insufficient, and it may be difficult to provide the application.

For example, when the bit rate of the video required by the video distribution application is higher than the bandwidth that can be used on the distribution route after the switching, packets of the video data are partially lost. The packets to be lost differ depending on settings of a network device, and hence an application provider cannot control the quality of providing the application, which may cause frame dropping in the video data or may inhibit the video data from continuing to be reproduced.

At this time, the application provider controls a resource for guaranteeing quality of the application in accordance with a situation of the network, which can improve the quality finally provided to the user.

For example, the application provider that provides the video distribution application changes the bit rate of the video data in accordance with the situation of the network, to thereby allow an event that considerably impairs the quality of the application, such as the frame dropping or stopped reproduction of the video, to be avoided when the bandwidth is insufficient on the network in spite of deterioration in the quality of the video.

Those methods for improving the quality of the application by the application provider, in which control for improving the quality is executed not by the network administrator but by the application provider, can be realized even when the number of applications that use the network is enormous.

However, it is not possible to improve the quality appropriately unless the application provider knows a method and a degree of the control of the resource which are necessary to improve final quality. Therefore, even when the application provider controls the resource, the application provider needs to acquire the network quality information in the same manner as in the case of using the control method such as Haiyong.

The application provider calculates the network quality information provided to the application based on information collected from each of the network devices provided to the network.

In the case where a plurality of applications are provided, the network quality information on each of the applications may differ between the applications even when the network device through which data passes is the same. Specifically, the network device generally performs communications by using a plurality of ports, and even the data that passes through the same network device differs in communication quality when the port through which the data passes differs.

Further, when the network provides a quality of service (QoS) class, the network devices provided to the network perform priority control or bandwidth control in accordance with the QoS class to which the application belongs. Therefore, in order to acquire the network quality information on the application, the application provider needs to acquire the communication quality of a class to which the application belongs from the network device.

In order to appropriately perform the switching of the transmitting client by the application provider, the control of the resource for the application, or the like, it is necessary to acquire the network quality information on the network.

A network management system on a large-scale network is generally provided with a function of periodically monitoring each of the network devices. However, a related-art network management system does not sufficiently monitor the network quality of each of ports provided to the network device or of each service class (QoS class).

This is because the number of ports included in the network device or the number of QoS classes provided by the network is extremely large, and a load imposed on the network device is heavy when all pieces of network quality information relating to the ports or the QoS classes are acquired. Accordingly, it is unrealistic to constantly keep acquiring the network quality corresponding to all services provided by the network from the network device.

### SUMMARY

An object of this invention is to provide a method of acquiring network quality information necessary to appropriately provide an application and suppressing a load on a network device for the acquisition.

Another object of this invention is to provide a method of narrowing down a network device for acquiring network quality information and the network quality information to be acquired in accordance with the application, to thereby reduce a load on the network device.

A representative example of this invention is a network system, comprising: a plurality of network devices; a network management apparatus coupled to the plurality of network devices; and an application management apparatus coupled to the network management apparatus. The plurality of network devices comprise at least one edge network device for passing traffic therethrough one of first and last among the plurality of network devices. The at least one edge network device is coupled to one of a provision source for providing an application by the traffic and a provision destination to be provided with the application. The application management apparatus transmits an information acquisition request indicating the application and the provision source of the application to the network management apparatus. The network management apparatus comprises a topology storage area indicating the at least one edge network device. The network management apparatus is configured to receive the transmitted information acquisition request. The network management apparatus is configured to generate, based on the topology storage area, an application edge device list indicating the at least one edge network device through which the traffic for providing the application indicated by the information acquisition request passes. The network management apparatus is configured to identify a route through which the traffic for providing the application indicated by the information acquisition request passes, based on the generated application edge device list and the provision source of the application indicated by the information acquisition request. The network management apparatus is configured to acquire quality information on the identified route. The network management apparatus is configured to transmit the acquired quality information to the application management apparatus.

According to one embodiment of this invention, the network quality information necessary to appropriately acquire the application is acquired, and the load on the network device for the acquisition is reduced.

### BRIEF DESCRIPTION OF THE DRAWINGS

FIG. 1 is a block diagram illustrating a configuration of a communication system according to a first embodiment.

FIG. 2 is a block diagram illustrating a configuration of an application management system according to the first embodiment.

FIG. 3 is an explanatory diagram showing an example of a service status recording part according to the first embodiment.

FIG. 4 is an explanatory diagram showing an example of a service information recording part according to the first embodiment.

FIG. 5 is a block diagram illustrating a configuration of a network management system according to the first embodiment.

FIG. 6 is an explanatory diagram showing an example of an agent sort recording part according to the first embodiment.

FIG. 7 is an explanatory diagram showing an example of a network topology recording part according to the first embodiment.

FIG. 8 is an explanatory diagram showing an example of a route recording part according to the first embodiment.

FIG. 9 is an explanatory diagram showing an example of a network status recording part according to the first embodiment.

FIG. 10 is an explanatory diagram showing an example of a routing information recording part according to the first embodiment.

FIG. 11 is an explanatory diagram showing an example of an address-edge device recording part according to the first embodiment.

FIG. 12 is a sequence diagram illustrating processing for acquiring network quality information from a communication network according to the first embodiment.

FIG. 13 is a flowchart illustrating a first half of processing for identifying a server-side edge network device according to the first embodiment.

FIG. 14 is a flowchart illustrating a second half of the processing for identifying the server-side edge network device according to the first embodiment.

FIG. 15 is a flowchart illustrating processing for identifying, by an information acquiring agent, a route between two edge network devices according to the first embodiment.

FIG. 16 is an explanatory diagram illustrating and showing an example of information provided to the application management system from the network management system according to the first embodiment.

FIG. 17 is a block diagram illustrating functions of a network management system according to a second embodiment.

FIG. 18 is a sequence diagram illustrating processing performed among an application management system, the network management system, and network devices according to the second embodiment.

### DETAILED DESCRIPTION OF THE EMBODIMENTS

### First Embodiment

Now, a description is made of a network management system in which predetermined information is acquired from a network device in response to a request received from an application management system and is provided to the application management system.

A network device according to a first embodiment is a network device managed by the network management system, and determines routing of each of received packets based on a protocol for the packet or the like. The network management system according to this embodiment periodically monitors each of network devices, to examine a life status of the network device or the like.

On the other hand, the network management system according to the first embodiment does not collect or hold in advance routing information included in the network device or the like. By processing according to the first embodiment described below, the network management system collects the routing information from the network device.

Further, the network management system according to the first embodiment may collect in advance rough statistical information on the interface or the like from the network device, but does not hold in advance all pieces of detailed information relating to the application whose traffic passes through the network device.

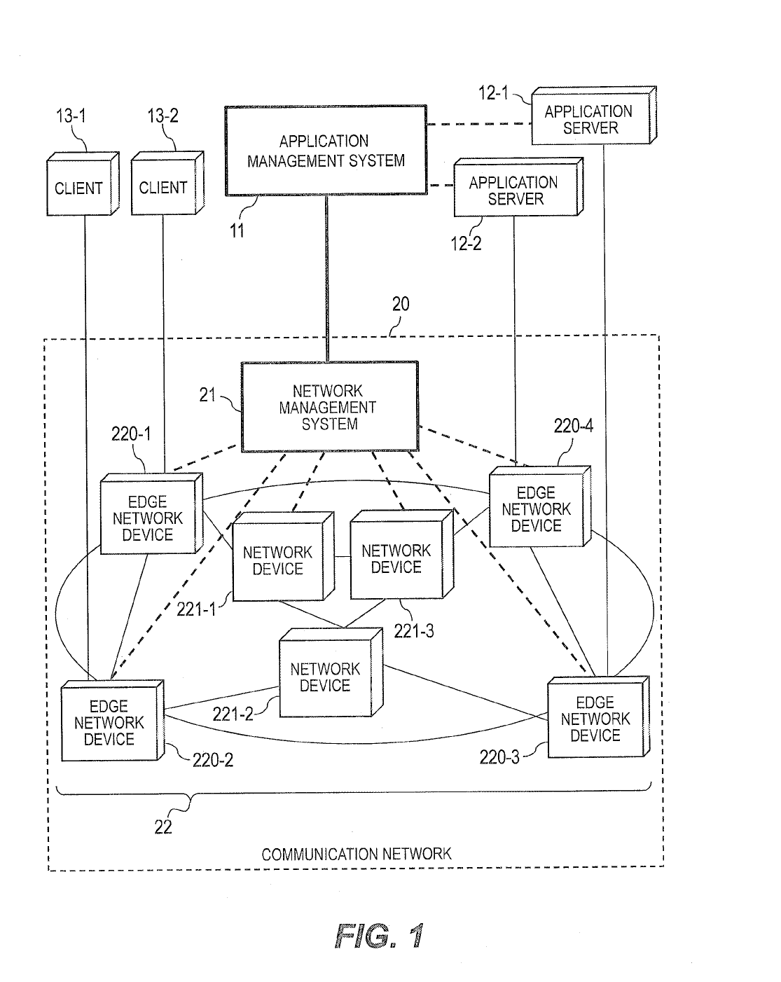

FIG. 1 is a block diagram illustrating a configuration of a communication system according to the first embodiment.

The communication system according to this embodiment includes an application management system 11, at least one client 13 (13-1 or 13-2), at least one application server 12 (12-1 or 12-2), and a communication network 20.

The application server 12 is a computer for providing an application to the client 13 through the communication network 20, and holds data on the application. The application server 12 is managed by the application management system 11.

The application management system 11 is a computer including at least one processor. The application management system 11 holds information relating to the client 13 based on a track record of providing the application to the client 13 by the application server 12. the application management system 11 is coupled to the application server 12 as necessary.

The client 13 is a computer to which the application is provided, and includes an output apparatus and an input apparatus as necessary. The client 13 may be, for example, a mobile terminal, such as a cellular phone and a smartphone, or a personal computer.

The communication network 20 includes a plurality of network devices 22 and a network management system 21. The network device 22 includes at least one edge network device 220 (220-1, 220-2, 220-3, or 220-4) and at least one network device 221 (221-1, 221-2, or 221-3).

The network management system 21 is coupled to all the network devices 22 provided to the communication network 20, and collects information from the network device 22.

The edge network device 220 and the network device 221 are the network devices 22 having the same functions. The edge network device 220 and the network device 221 are different in that the edge network device 220 is coupled to an apparatus other than the network device 22 coupled to the network management system 21.

Further, the edge network device 220 and the network device 221 are further different in that the edge network device 220 passes the traffic therethrough first or last among the network devices 22. The respective network devices 22 are coupled to each other as necessary.

The application server 12 and the client 13 are coupled to each other through at least one edge network device 220, and coupled to each other through the network device 221 as necessary. The application server 12 and the client 13 may be each coupled directly to the edge network device 220, or may be coupled to the edge network device 220 through a network or a network device that is not coupled to the network management system 21.

In the following description, in a case where the edge network device 220 passes the traffic addressed to the application server 12 therethrough last among the network devices 22 and passes the traffic from the application server 12 therethrough first among the network devices 22, this edge network device 220 is referred to as “server-side edge network device”.

Further, in a case where the edge network device 220 passes the traffic addressed to the client 13 therethrough last among the network devices 22 and passes the traffic from the client 13 therethrough first among the network devices 22, this edge network device 220 is referred to as “client-side edge network device”.

The server-side edge network device is an edge network device 220 that can be reached by the application server 12 at the smallest hop count. Therefore, in this embodiment, the application server 12 and the server-side edge network device are provided on a one-to-one basis.

Each of the network devices 22 has a function of monitoring and holding detailed information on the traffic passing through the own network device 22 periodically or in accordance with an instruction received from the network management system 21. The network management system 21 has a function of setting each of the network devices 22 in regard to the monitoring performed by the network device 22.

In the first embodiment, each of the devices included in the communication network 20 is set in advance to provide at least one service class to the application server 12 and the client 13. Each of the network devices 22 performs communication bandwidth control or the like for each service class. Further, a routing table held by each of the network devices 22 may indicate routing that differs for each service class.

Each of the network devices 22 transfers the traffic input to the application server 12, the client 13, or the network device that is coupled to the own network device 22 based on the held routing table and the input information on the traffic (packet).

Further, each of the network devices 22 may transfer the traffic to the application server 12, the client 13, or the network device that is coupled to the own network device 22 based on a transmission destination network address and a transmission source network address indicated by the traffic. Such a routing policy may be autonomously set by the network device in accordance with a specific protocol, or may be set by the network management system 21.

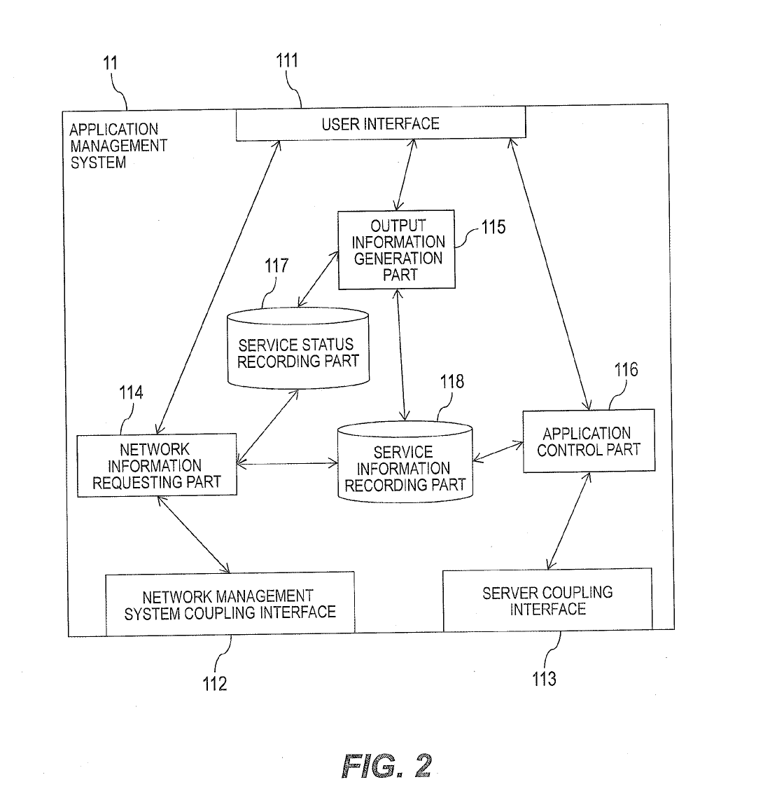

FIG. 2 is a block diagram illustrating a configuration of the application management system 11 according to the first embodiment.

The application management system 11 includes: interfaces such as a user interface 111, a network management system coupling interface 112, and a server coupling interface 113; processing parts such as a network information requesting part 114, an output information generation part 115, and an application control part 116; and recording parts such as a service status recording part 117 and a service information recording part 118. Further, the application management system 11 includes at least one processor, a memory, and a network interface.

The user interface 111 is, for example, an interface connected to a display, a printer, or the like, for providing the user with information. Further, the user interface 111 is, for example, an interface connected to a keyboard, a touchpad, or the like, for receiving an input from the user.

The network management system coupling interface 112 is an interface for coupling to the network management system 21. The server coupling interface 113 is an interface for coupling to the application server 12.

The application management system 11 has a control function for changing a method of providing the application server 12 with the application by using the application control part 116 described later. Specifically, the application management system 11 can switch the application server 12 for providing the application, or can control the application server 12 to change quality of providing the application.

The application management system 11 may automatically execute the control function for the application described above when network quality information is transmitted from the network management system 21, and may execute the control function when receiving an instruction from the user.

The application management system 11 and the application server 12 may provide one application, or may provide a plurality of applications.

The network information requesting part 114 transmits an information acquisition request for requesting to acquire information on the communication network 20 to the network management system 21 through the network management system coupling interface 112 based on the information acquired from the service information recording part 118. Further, the network information requesting part 114 stores information relating to the communication network 20 received from the network management system 21 into the service status recording part 117.

The network information requesting part 114 transmits the information acquisition request periodically or when instructed by the user to acquire the information through the user interface 111.

The output information generation part 115 generates output information to be presented to the user based on the information of the service status recording part 117 and the information of the service information recording part 118. Then, the output information generation part 115 provides the generated output information to the user through the user interface 111.

The application control part 116 controls the application server 12 through the server coupling interface 113 in accordance with an instruction received from the user or the information stored in the service information recording part 118, and further acquires the information from the application server 12.

The service status recording part 117 holds the network quality information for each route through which the traffic of the application passes.

The service information recording part 118 indicates the application being provided by the application server 12. The service information recording part 118 according to this embodiment indicates the application and a network address of the application server 12 that is providing the application.

Each of the processing parts included in the application management system 11 may be implemented by at least one physical device such as an integrated circuit, or may be implemented by at least one program executed by the processor. Further, all the processing parts included in the application management system 11 may be implemented by one physical device or one program.

Further, the application management system 11 may include a storage device for storing the service status recording part 117 and the service information recording part 118.

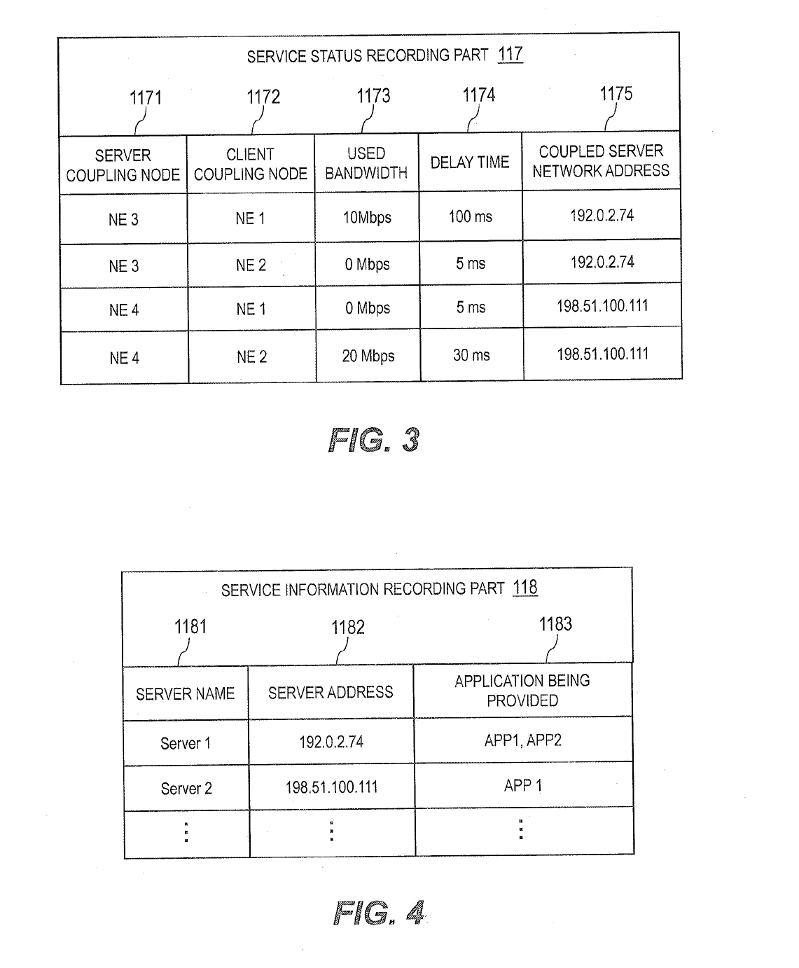

FIG. 3 is an explanatory diagram showing an example of the service status recording part 117 according to the first embodiment.

The service status recording part 117 includes a server coupling node 1171, a client coupling node 1172, a used bandwidth 1173, a delay time 1174, and a coupled server network address 1175.

The server coupling node 1171 indicates the server-side edge network device. The client coupling node 1172 indicates the client-side edge network device.

The used bandwidth 1173 indicates statistics (for example, average value) of a used bandwidth on a route between the edge network device 220 indicated by the server coupling node 1171 and the edge network device 220 indicated by the client coupling node 1172. The delay time 1174 indicates statistics (for example, cumulative value) of a delay time on the route between the edge network device 220 indicated by the server coupling node 1171 and the edge network device 220 indicated by the client coupling node 1172.

The coupled server network address 1175 indicates an address of the application server 12 to which the edge network device 220 indicated by the server coupling node 1171 is coupled.

The application provided through the communication network 20 always belongs to any one of the service classes. Therefore, the network quality information indicated by the service status recording part 117 is the network quality information for each service class and for each application.

FIG. 4 is an explanatory diagram showing an example of the service information recording part 118 according to the first embodiment.

The service information recording part 118 includes a server name 1181, a server address 1182, and an application being provided 1183. The server name 1181 indicates an identifier of the application server 12.

The server address 1182 indicates a network address of the application server 12 used on the network device 22. The application being provided 1183 indicates an identifier of the application being provided to the client 13 by the application server 12 indicated by the server name 1181.

When the user inputs the identifier of the application server 12 or the identifier of the application through the user interface 111 to request for the information acquisition from the network device 22, the network information requesting part 114 extracts an entry corresponding to the input identifier of the application server 12 or an entry corresponding to the identifier of the application from the service information recording part 118. Then, the network information requesting part 114 generates the information acquisition request including at least values of the server address 1182 and the application being provided 1183 of the extracted entry.

Here, the information acquisition request according to this embodiment is a request transmitted from the application management system 11 to the network management system 21 when the network quality information relating to the application is to be acquired from the network device 22.

The information acquisition request includes at least the identifier of the application on which the network management system 21 is to acquire the network quality information and the network address of the application server 12 to provide the application to the client 13. Further, the information acquisition request may indicate not only the identifier of the application and the like but also the kind of network quality information to be acquired as necessary.

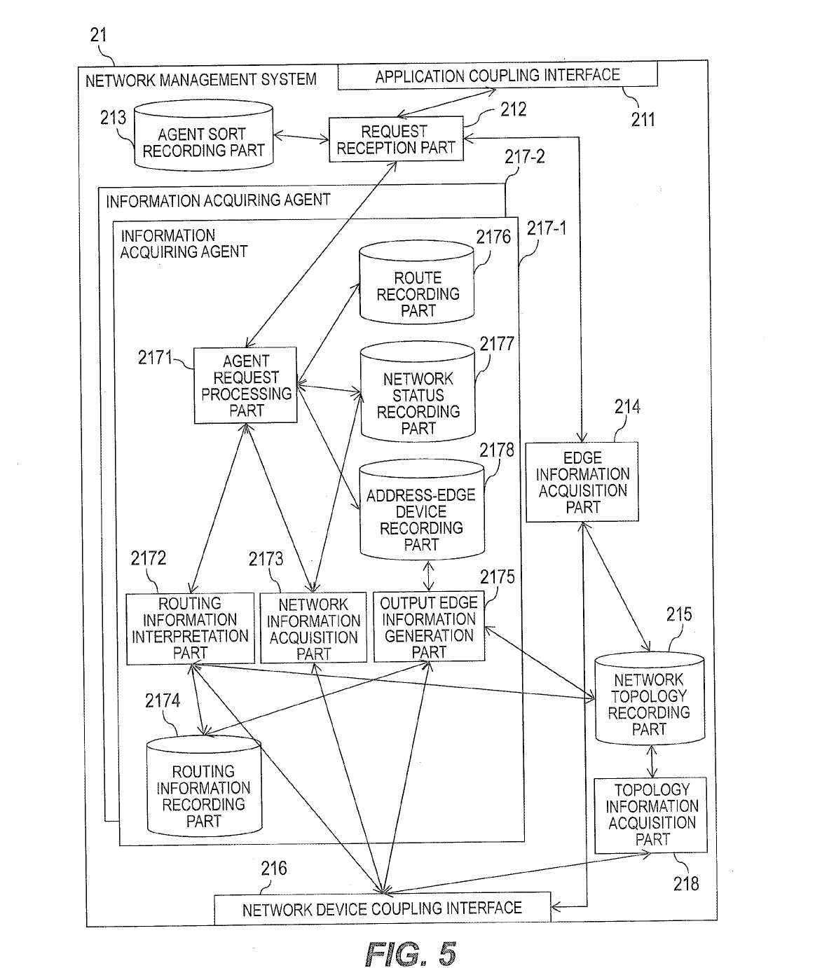

FIG. 5 is a block diagram illustrating a configuration of the network management system 21 according to the first embodiment.

The network management system 21 includes: interfaces such as an application coupling interface 211 and a network device coupling interface 216; processing parts such as a request reception part 212, an edge information acquisition part 214, at least one information acquiring agent 217 (217-1 or 217-2), and a topology information acquisition part 218; and recording parts such as an agent sort recording part 213 and a network topology recording part 215. Further, the network management system 21 includes at least one processor, a memory, and a network interface.

The application coupling interface 211 is an interface for communicating to/from the application management system 11. The network device coupling interface 216 is an interface for communicating to/from the network device 22 included in the communication network 20.

When the information acquisition request is transmitted from the application management system 11, the request reception part 212 determines the information acquiring agent 217 to process the information acquisition request based on the transmitted information acquisition request and the agent sort recording part 213. Then, the request reception part 212 transfers the information acquisition request transmitted from the application management system 11 to the determined the information acquiring agent 217. The agent sort recording part 213 indicates the application on which each of the information acquiring agents 217 acquires the network quality information.

When the identifier of the application is input from the request reception part 212, the edge information acquisition part 214 outputs, to the request reception part 212, the edge network device 220 through which the traffic of the application indicated by the input identifier of the application among the edge network devices 220 of the communication network 20.

The network topology recording part 215 holds network configurations of all the network devices 22. The network configuration held by the network topology recording part 215 indicates the interface provided to each of the network devices 22, the network address assigned to the interface, and whether or not the interface is coupled to a network or an device outside the communication network 20.

The topology information acquisition part 218 acquires the network configuration from the network device 22, and stores the acquired network configuration into the network topology recording part 215.

The information acquiring agent 217 collects the information from the network device 22 based on the information acquisition request input from the request reception part 212, and consolidates the collected information. A plurality of information acquiring agents 217 may be installed in accordance with a combination of applications that can share the information of the recording parts included in the information acquiring agent 217. Further, one information acquiring agent 217 may be installed in the network management system 21 so as to be able to process the information acquisition request relating to one application.

The information acquiring agent 217 includes: processing parts such as an agent request processing part 2171, a routing information interpretation part 2172, a network information acquisition part 2173, and an output edge information generation part 2175; and recording parts such as a route recording part 2176, a network status recording part 2177, an address-edge device recording part 2178, and a routing information recording part 2174.

The agent request processing part 2171 receives the information acquisition request from the request reception part 212. The agent request processing part 2171 updates each of the recording parts within the information acquiring agent 217 as necessary, and extracts the information from each of the recording parts. In addition, the information to be provided to the application management system 11 is generated based on the information extracted from each of the recording parts.

The route recording part 2176 holds information indicating the route between two edge network devices 220.

The network status recording part 2177 holds the network quality information on each of the network devices 22 for each application. The network quality information on the network device 22 represents information including an available bandwidth, a delay time, and a traffic amount on the network device 22.

The network status recording part 2177 may hold the value acquired from the network device 22 as it is. Further, the network status recording part 2177 may hold statistics generated based on the information acquired continuously from the network device 22.

The network information acquisition part 2173 acquires the network quality information on the network device 22 and the network quality information on the interface included in the network device 22 in accordance with an instruction received from the agent request processing part 2171.

The routing information interpretation part 2172 identifies, based on the network address input from the agent request processing part 2171, the server-side edge network device corresponding to the application server 12 to which the network address is assigned.

Further, when the information relating to the two edge network devices 220 is input from the agent request processing part 2171, the routing information interpretation part 2172 identifies the route between the two edge network devices 220 within the communication network 20.

In order to provide such functions, the routing information interpretation part 2172 searches the routing information recording part 2174 based on the network address to acquire the routing information. Further, the routing information interpretation part 2172 acquires the routing information held by the network device 22 through the network device coupling interface 216. Further, the routing information interpretation part 2172 adds the acquired routing information to the routing information recording part 2174.

The routing information recording part 2174 holds the routing information on the network device 22. When the network address of the application server 12 is input from the routing information interpretation part 2172, the routing information recording part 2174 returns the routing information corresponding to the input network address to the routing information interpretation part 2172.

When the routing information corresponding to the input network address is not held, the routing information recording part 2174 notifies the routing information interpretation part 2172 that the routing information is not held.

It should be noted that, when the routing information is input from the routing information interpretation part 2172, causing a storage capacity of the routing information recording part 2174 to reach an upper limit, the routing information recording part 2174 may delete all or a part of the held routing information in accordance with a predetermined algorithm. Here, the predetermined algorithm is, for example, an algorithm for deleting the routing information that has been held for the longest period of time after being added.

The output edge information generation part 2175 generates the information of the address-edge device recording part 2178. The output edge information generation part 2175 acquires the routing information on the edge network device 220 from the routing information recording part 2174. At this time, when routing information on a desired edge network device 220 does not exist in the routing information recording part 2174, the output edge information generation part 2175 requests the desired edge network device 220 for the routing information, and adds the routing information to the routing information recording part 2174.

Then, the output edge information generation part 2175 determines whether or not the output interface of the edge network device 220 is coupled to the apparatus or the network outside the communication network 20 based on an output interface indicated by the routing information and the network topology recording part 215. When the output interface is coupled to the apparatus or the like outside the communication network 20, the output edge information generation part 2175 adds the information on the output interface to the address-edge device recording part 2178.

The output edge information generation part 2175 may use the network address indicated by the information acquisition request received from the application management system 11 to search the address-edge device recording part 2178 and acquire the identifier indicating the edge network device 220 as a search result. Then, the acquired identifier of the edge network device 220 may be transmitted to the application management system 11 through the agent request processing part 2171 and the request reception part 212.

This function is used by the application management system 11 to identify the client-side edge network device corresponding to the client 13 to be provided with the application. To use this function, the application management system 11 can include the network address of the client 13 in the information acquisition request.

Each of the processing parts included in the network management system 21 may be implemented by at least one physical apparatus such as an integrated circuit, or may be implemented by at least one program executed by the processor. Further, all the processing parts included in the network management system 21 may be implemented by one physical apparatus or one program.

Further, the network management system 21 may include a storage for storing each of the recording parts.

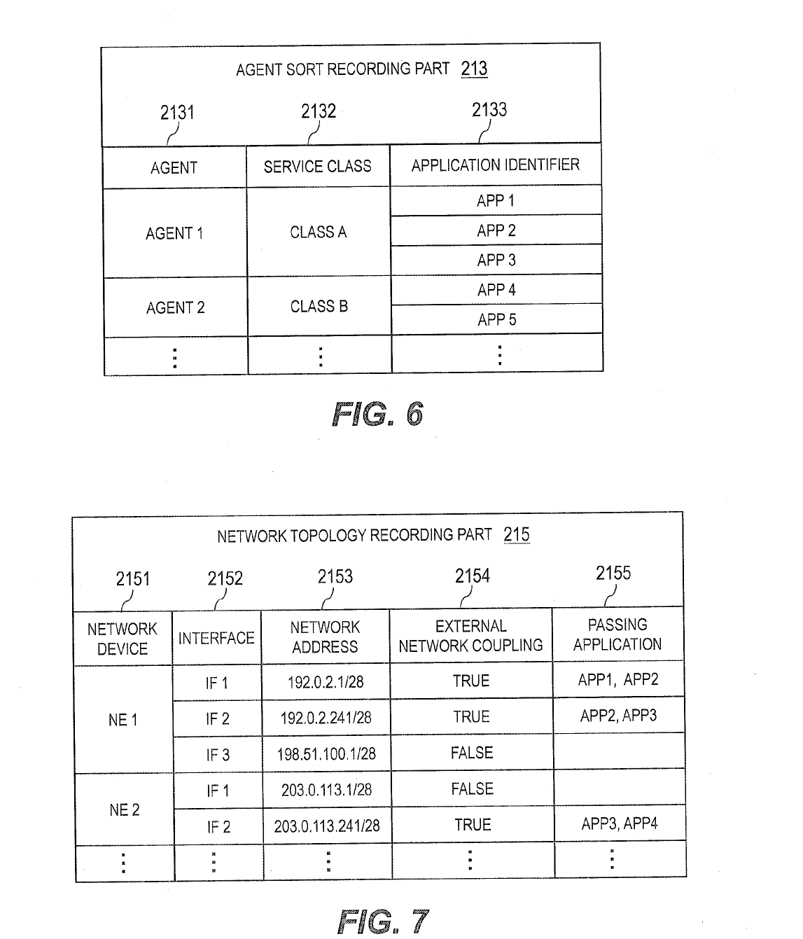

FIG. 6 is an explanatory diagram showing an example of the agent sort recording part 213 according to the first embodiment.

FIG. 6 is an example of the agent sort recording part 213 in a case where the respective information acquisition requests are sorted to the information acquiring agents 217 in accordance with the service class provided by the communication network 20. The agent sort recording part 213 of FIG. 6 indicates the service class to which each of the applications belong.

The agent sort recording part 213 includes an agent 2131, a service class 2132, and an application identifier 2133. The values of the agent sort recording part 213 are set in advance by the administrator.

The agent 2131 indicates an identifier of the information acquiring agent 217. The service class 2132 indicates the service class provided by the communication network 20. The application identifier 2133 indicates the identifier of the application provided by the application server 12.

The request reception part 212 extracts the entry of the agent sort recording part 213 including the same application identifier 2133 as the identifier of the application indicated by the information acquisition request, and determines the information acquiring agent 217 indicated by the agent 2131 of the extracted entry as the information acquiring agent 217 for executing processing corresponding to the received information acquisition request.

It should be noted that, in the agent sort recording part 213 shown in FIG. 6, the values of the agent 2131 and the service class 2132 have a one-to-one relationship, but the agent sort recording part 213 according to this embodiment is not limited thereto. For example, one identifier of the agent 2131 may correspond to the values of a plurality of service classes 2132.

This is because the same route is likely to be used for the applications having the same service class and, when the same route is used, the routing information on the network device 22 to be held by each of the information acquiring agents 217 is also the same. Further, the same information acquiring agent 217 processes each of a plurality of applications having the same service class so that the plurality of applications can share the routing information, and the information acquiring agent 217 can thus efficiently refer to the information.

FIG. 7 is an explanatory diagram showing an example of the network topology recording part 215 according to this embodiment.

The network topology recording part 215 includes a network device 2151, an interface 2152, a network address 2153, an external network coupling 2154, and a passing application 2155.

The information of the network device 2151, the interface 2152, the network address 2153, and the external network coupling 2154 may be set in advance by the administrator, or may be stored in advance based on the information acquired from the network device 22. The information of the passing application 2155 is acquired and updated by the topology information acquisition part 218.

The network device 2151 indicates an identifier of the network device 22 of the edge network device 220 or the network device 221. The interface 2152 indicates an identifier of the interface included in each of the network devices 22.

The network address 2153 indicates the network address assigned to each of the interfaces of the network device 22 indicated by the network device 2151. The external network coupling 2154 indicates whether or not the interface indicated by the interface 2152 is coupled to the apparatus, the network, or the like installed outside the communication network 20.

The external network coupling 2154 shown in FIG. 6 indicates the coupling to the apparatus installed outside the communication network 20 when the held value is “True”, and indicates not coupling to the apparatus installed outside the communication network 20 when the held value is “False”.

The passing application 2155 indicates the application whose traffic passes through the interface indicated by the interface 2152 by including the identifier of the application.

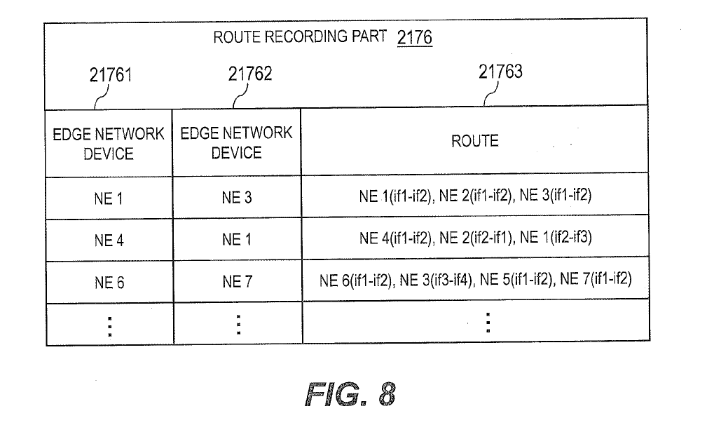

FIG. 8 is an explanatory diagram showing an example of the route recording part 2176 according to the first embodiment.

The route recording part 2176 includes an edge network device 21761, an edge network device 21762, and a route 21763. The information of the route recording part 2176 is updated by processing described later.

The edge network device 21761 and the edge network device 21762 each indicate an identifier of the edge network device 220. The route 21763 indicates the route between the two edge network devices 220 indicated by the edge network device 21761 and the edge network device 21762.

The route 21763 shown in FIG. 8 indicates the route by the identifier of the network device 22 included in the route and the identifier of the interface of the network device 22 included in the route.

It should be noted that, when any one of the routes within the communication networks 20 is switched due to a failure or the like, the route recording part 2176 may be updated.

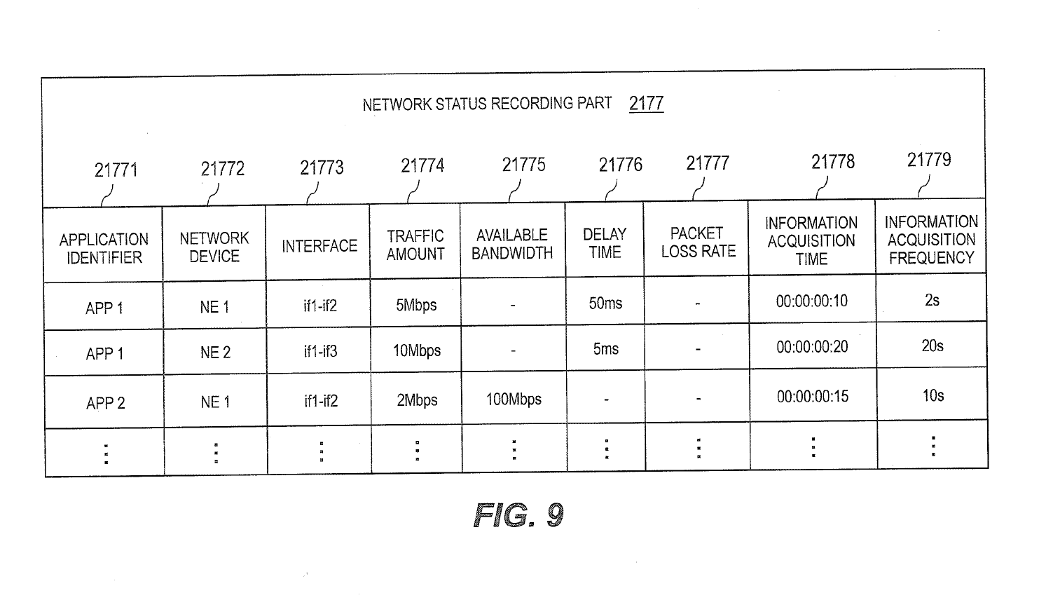

FIG. 9 is an explanatory diagram showing an example of the network status recording part 2177 according to the first embodiment.

The network status recording part 2177 includes values in accordance with kinds of the network quality information acquired from the network device 22. The network status recording part 2177 includes an application identifier 21771, a network device 21772, an interface 21773, network information (traffic amount 21774, available bandwidth 21775, delay time 21776, and packet loss rate 21777), an information acquisition time 21778, and an information acquisition frequency 21779.

The application identifier 21771 indicates the identifier of the application. The network device 21772 indicates the identifier of the network device 22. The interface 21773 indicates the interface of the network device 22 indicated by the network device 21772, and indicates a combination of interfaces through which the traffic of the application passes.

The traffic amount 21774 indicates an amount of the traffic passing through the combination of interfaces. The available bandwidth 21775 indicates a bandwidth that can be used by the traffic of the application. The delay time 21776 indicates a delay time that occurs when the traffic is transferred on the network device. The packet loss rate 21777 indicates a ratio of the packet deleted on the network device 22.

The information acquisition time 21778 indicates a time at which the network information was acquired last. The information acquisition frequency 21779 indicates how often the network information is acquired from the network device 22.

The kinds of information included in the network status recording part 2177 depend on the information acquisition request transmitted from the application management system 11. Therefore, the network status recording part 2177 according to this embodiment may not necessarily include all pieces of the network information shown in FIG. 9, and may include the information other than the network information shown in FIG. 9. Further, the kinds of the information included in the network status recording part 2177 may differ for each application identifier.

Specifically, the network status recording part 2177 of FIG. 9 indicates that the information of the traffic amount 21774 and the delay time 21776 has been acquired as the network quality information in regard to the application of the identifier (APP1). Further, the network status recording part 2177 of FIG. 9 indicates that the information of the traffic amount 21774 and the available bandwidth 21775 has been acquired as the network quality information in regard to the application of the identifier (APP2).

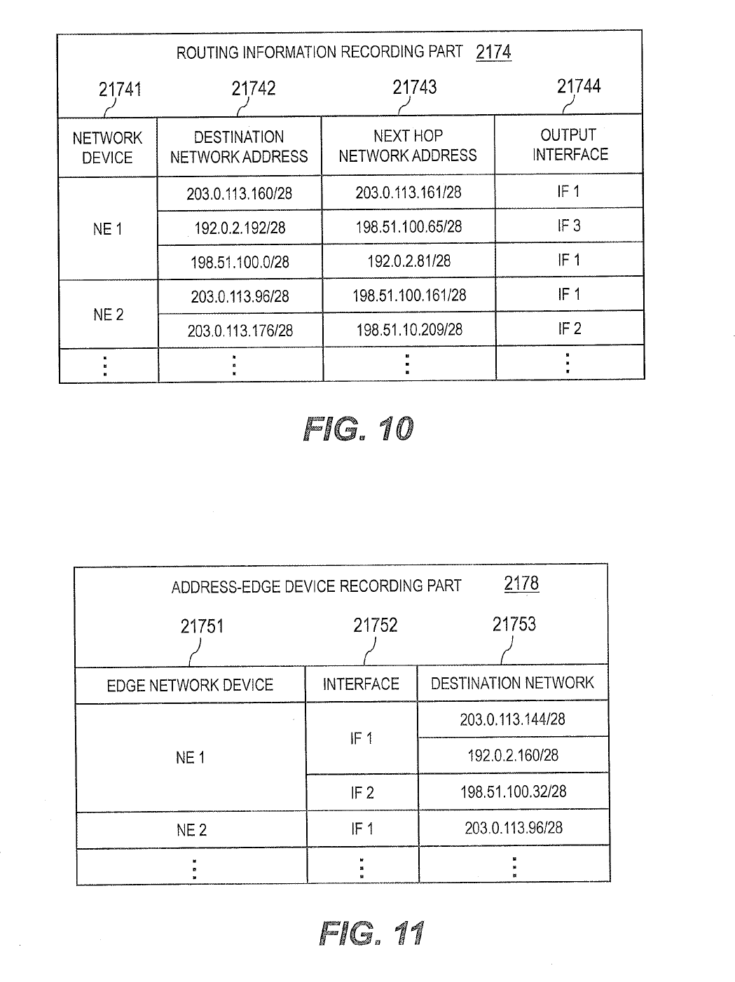

FIG. 10 is an explanatory diagram showing an example of the routing information recording part 2174 according to the first embodiment.

The routing information recording part 2174 includes a network device 21741, a destination network address 21742, a next hop network address 21743, and an output interface 21744. The routing information recording part 2174 indicates a destination of the traffic passing through each of the network devices 22, but the routing information recording part 2174 according to the first embodiment does not need to include destinations of the traffic of all the network devices 22.

The network device 21741 indicates the identifier of the network device 22. The destination network address 21742 indicates the network address of the application server 12. The next hop network address 21743 indicates the network address to which the interface indicated by the output interface 21744 is coupled. The output interface 21744 indicates the identifier of the interface.

It should be noted that, when any one of the routes within the communication network 20 is switched due to the failure or the like, the routing information recording part 2174 may be updated. Further, in the following description, each entry of the routing information recording part 2174 may be referred to as “routing information”.

FIG. 11 is an explanatory diagram showing an example of the address-edge device recording part 2178 according to the first embodiment.

The address-edge device recording part 2178 includes an edge network device 21751, an interface 21752, and a destination network 21753. The edge network device 21751 indicates the identifier of the edge network device 220.

The interface 21752 indicates the identifier of the interface included in the edge network device 220. The destination network 21753 indicates the network address of the destination of the traffic passing through the interface 21752.

The address-edge device recording part 2178 is generated by the output edge information generation part 2175 based on the routing information recording part 2174 and the network topology recording part 215.

Specifically, the output edge information generation part 2175 refers to the routing information recording part 2174 shown in FIG. 10 to acquire the routing information on the edge network device 220 of the identifier (NE1). Then, the output edge information generation part 2175 refers to the network topology recording part 215 shown in FIG. 7 to extract the entry having the external network coupling 2154 indicating “True” from among the entries having the network device 2151 indicating “NE1”, and acquires the interface 2152 of the extracted entry.

In the example shown in FIG. 7, the interface 2152 of the entry having the network device 2151 indicating “NE1” and the external network coupling 2154 indicating “True” indicates “IF1” and “IF2”. Therefore, the output edge information generation part 2175 extracts the entry having the output interface 21744 indicating “IF1” and the entry having the output interface 21744 indicating “IF2” from among the entries having the network device 21741 indicating “NE1”, and adds the destination network address 21742 of the extracted entries to the address-edge device recording part 2178.

The output edge information generation part 2175 may generate (update) the address-edge device recording part 2178 when the agent request processing part 2171 receives the information acquisition request, or may generate (update) the address-edge device recording part 2178 every predetermined period. Further, the output edge information generation part 2175 may generate (update) the address-edge device recording part 2178 when the network topology recording part 215 is updated.

Next, a description is made of a flow of processing according to this embodiment.

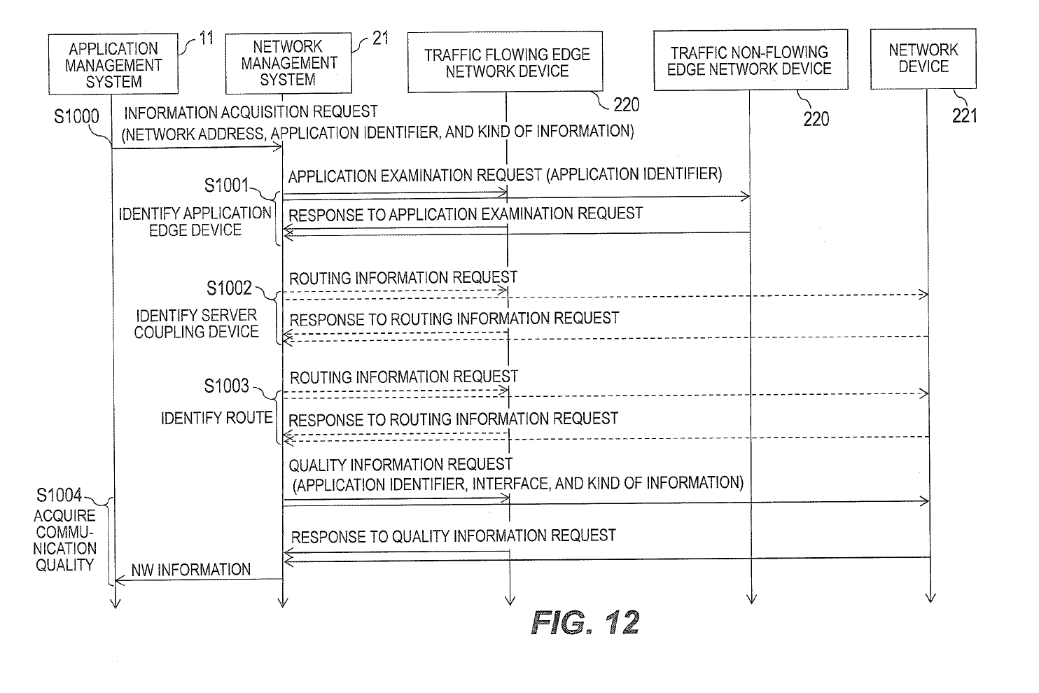

FIG. 12 is a sequence diagram illustrating processing for acquiring the network quality information from the communication network 20 according to the first embodiment.

FIG. 12 illustrates a flow of the information transmitted/received among the application management system 11, the network management system 21, and the network device 22.

The application management system 11 transmits the information acquisition request to the network management system 21 (S1000).

After Step S1000, the network management system 21 identifies the edge network device 220 that passes therethrough the traffic relating to the application indicated by the information acquisition request from among the network devices 22. Then, the network management system 21 generates the application edge device list indicating the identified edge network device 220 (S1001).

In Step S1001, the network management system 21 controls the edge network device 220 to examine the application whose traffic passes therethrough.

After Step S1001, the network management system 21 identifies the server-side edge network device and the client-side edge network device based on the application edge device list, the routing information recording part 2174, and the information acquisition request (S1002). In Step S1002, the network management system 21 acquires the routing information from the network device 22 as necessary.

After Step S1002, the network management system 21 identifies the route between the server-side edge network device and the client-side edge network device (S1003). In Step S1003, the network management system 21 acquires the routing information from the network device 22 as necessary.

After Step S1003, the network management system 21 acquires the network quality information on the identified route. Then, the network management system 21 provides the acquired network quality information to the application management system 11 (S1004).

In Step S1002, the network management system 21 identifies the server-side edge network device based on the application indicated by the information acquisition request, to thereby be able to narrow down the network device from which the network quality information relating to the application is to be acquired. Further, in Step S1003, the route is identified based on the identified server-side edge network device and the identified client-side edge network device, which can further narrow down the network device from which the network quality information is to be acquired.

This allows the network management system 21 to reduce a load imposed on each of the network devices 22 within the communication network 20 because the network quality information is acquired in Step S1004. Further, the application management system 11 includes the information on the application and the application server 12 in the information acquisition request, which allows the network management system 21 to acquire the network quality information with more efficiency.

Now, a detailed description is made of the processing illustrated in FIG. 12.

The information acquisition request indicates, for example, the available bandwidth or the delay time when indicating the kind of the network quality information to be acquired. Further, the information acquisition request may indicate the kinds of a plurality of pieces of the network quality information.

Further, the information acquisition request does not need to indicate the kind of the network quality information. Specifically, when the identifier of the application is designated by the user, the application management system 11 and the network management system 21 may identify the kind of the network quality information corresponding to the designated identifier of the application.

For example, the application management system 11 may hold an application type corresponding to each of the applications, and the network management system 21 may hold the kind of the network quality information corresponding to the application type. When the identifier of the application is designated by the user, the application management system 11 may transmit the information acquisition request to the network management system 21 by including therein the application type corresponding to the designated identifier, and the network management system 21 may identify the kind of the network quality information corresponding to the application type included in the information acquisition request.

More specifically, when the application is a video sharing service, the delay time or fluctuations in the delay time within the communication network 20 generally exerts a considerable influence on the quality of the application provided to the client 13. Therefore, the application management system 11 may transmit the “video” to the network management system 21 as the application type, and the network management system 21 may identify the “delay time” and “fluctuations in the delay time” corresponding to the “video” as the kind of the network quality information.

The identifier of the application indicated by the information acquisition request is unique among the application management system 11, the network management system 21, and the network device 22. Further, the network device 22 can determine whether or not the received traffic is the traffic relating to the designated application based on the received traffic and the identifier of the application designated by the network management system 21.

Further, when one application is provided from at least one application server 12 to which one network address is assigned, the network device 22 may use the network address of the application server 12 included in the information acquisition request as the identifier of the application. In other words, the network device 22 may identify the traffic relating to the application indicated by the information acquisition request based on the network address included in the information acquisition request and the network address for the packet transmitted/received by itself, and may acquire the network quality information by using the identified traffic.

Further, when a plurality of applications are provided from at least one application server 12 to which one network address is assigned, the network device 22 identifies the application by using the information on an upper layer included in the packet transmitted/received by itself. For example, when the communication network 20 uses a TCP/IP network, the network device 22 may use a port number (included in the packet) of TCP/UDP assigned to the application as the identifier of the application.

Here, the identifier of the application indicated by the information acquisition request corresponds to the port number. Then, based on the identifier of the application indicated by the information acquisition request and the port number in a transport layer of the packet transmitted/received by itself, the network device 22 may identify the traffic relating to the application indicated by the information acquisition request, and may acquire the network quality information by using the identified traffic.

When receiving the information acquisition request in Step S1000, the request reception part 212 determines the information acquiring agent 217 to execute the processing corresponding to the received information acquisition request based on the agent sort recording part 213 and the identifier of the application indicated by the received information acquisition request.

For example, when the received information acquisition request indicates the identifier of the application “APP1”, the request reception part 212 extracts “Agent1” from the entry having “APP1” as the application identifier 2133 within the agent sort recording part 213 shown in FIG. 6. Then, the request reception part 212 determines the information acquiring agent 217 of the extracted identifier “Agent1” as the information acquiring agent 217 to execute the processing corresponding to the information acquisition request.

Here, when the information acquisition request indicates a plurality of applications and when the information acquiring agents 217 determined for the plurality of applications are different from each other, the request reception part 212 may execute the processing of Steps S1002 and S1003 described later by the information acquiring agent 217 in parallel. Further, when the information acquisition request indicates a plurality of applications and when one information acquiring agent 217 is determined for at least two applications, the processing of Steps S1002 and S1003 is executed for each of the applications executed by one information acquiring agent 217.

It is assumed that the following processing of Steps S1001 and S1004 is executed for each application when a plurality of applications indicated by the information acquisition request are included. However, in Step S1004, the request reception part 212 of the network management system 21 may transmit the network quality information on the plurality of applications indicated by the information acquisition request to the application management system 11 as one piece of information.

After the information acquiring agent 217 to execute the processing corresponding to the information acquisition request is determined or while the information acquiring agent 217 is being determined, the request reception part 212 transmits an instruction to identify the edge network device 220 (hereinafter referred to as “application edge device”) through which the traffic relating to the application indicated by the information acquisition request passes, to the edge information acquisition part 214. Then, the edge information acquisition part 214 identifies the application edge device in accordance with an instruction received from the request reception part 212 (S1001).

In Step S1001, the request reception part 212 first transfers the identifier of the application indicated by the information acquisition request to the edge information acquisition part 214.

When receiving the identifier of the application from the request reception part 212, the edge information acquisition part 214 refers to the network topology recording part 215 to acquire a list of all the edge network devices 220. It should be noted that the acquired list of the edge network device 220 indicates all the edge network devices 220 included in the communication network 20, and includes both the edge network device 220 through which the traffic relating to the application indicated by the information acquisition request passes and the edge network device 220 through which the traffic does not pass.

Then, the edge information acquisition part 214 transmits an application examination request including the received identifier of the application to the edge network device 220 indicated by the acquired list through the network device coupling interface 216.

When receiving the application examination request, the edge network device 220 determines whether or not the traffic relating to the application indicated by the application examination request passes through the interface coupled to the device outside the communication network 20 among the interfaces included in itself. Then, the edge network device 220 returns a determination result to the edge information acquisition part 214.

The edge information acquisition part 214 updates the network topology recording part 215 based on the received determination result so that the identifier of the interface through which the traffic of the application indicated by the information acquisition request passes corresponds to the identifier of the application indicated by the information acquisition request. This allows the edge information acquisition part 214 to identify the application edge device from among all the edge network devices 220.

It should be noted that it is unclear which of the server-side edge network device or the client-side edge network device the application edge device identified here is. Therefore, the following processing of Step S1002 is started on the assumption that all the edge network devices 220 indicated by the network topology recording part 215 are the client-side edge network devices.

Further, when the edge network device 220 can examine the destination of the traffic of the application indicated by the application examination request by the own interface coupled to the apparatus outside the communication network 20, the edge network device 220 may transmit the destination of the traffic to the edge information acquisition part 214. Then, the edge information acquisition part 214 may distinguish between the edge network device 220 that has transmitted the destination and the edge network device 220 that does not transmit the destination, to execute Step S1002 for an edge network device that does not transmit the destination.

Further, the edge information acquisition part 214 may identify the server-side edge network device and the client-side edge network device based on the destination transmitted from the edge network device 220.

The edge information acquisition part 214 generates the application edge device list including the identified application edge device based on the updated network topology recording part 215. Then, the edge information acquisition part 214 transmits the application edge device list to the request reception part 212. The application edge device list includes the respective identifiers indicating the application edge device, the interface, and the application.

When the application edge device list is transmitted from the edge information acquisition part 214, the request reception part 212 transfers the transmitted application edge device list and the information acquisition request to the agent request processing part 2171 of the information acquiring agent 217 determined based on the agent sort recording part 213.

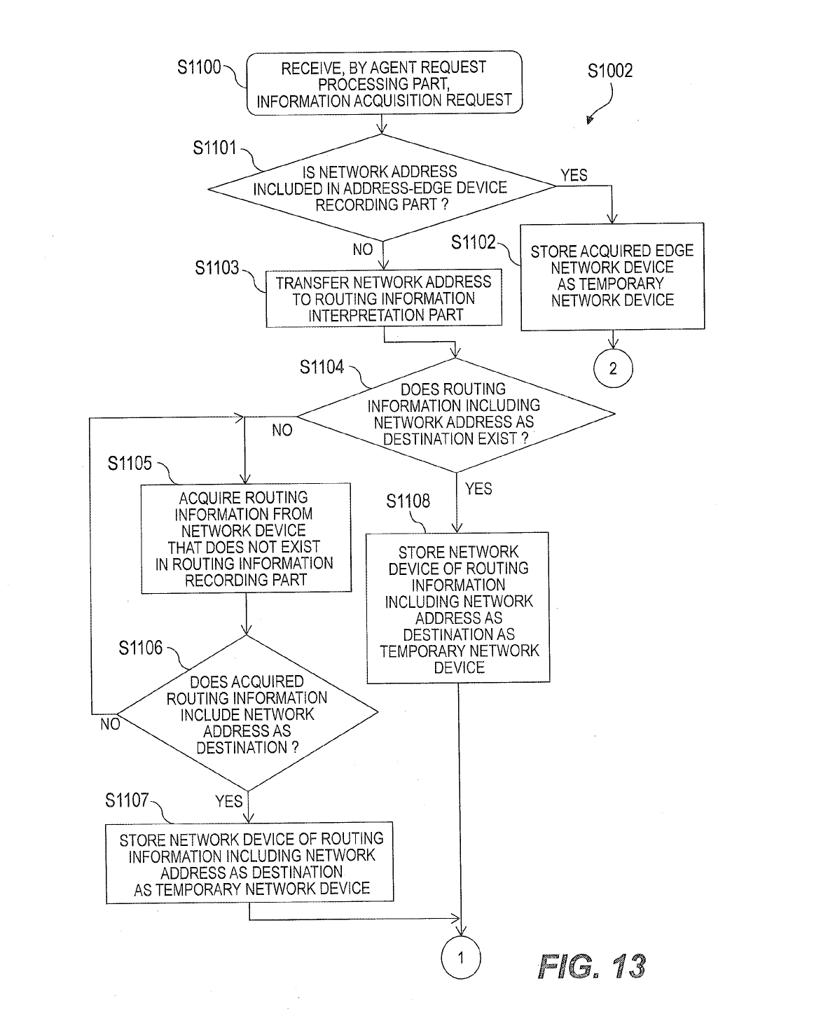

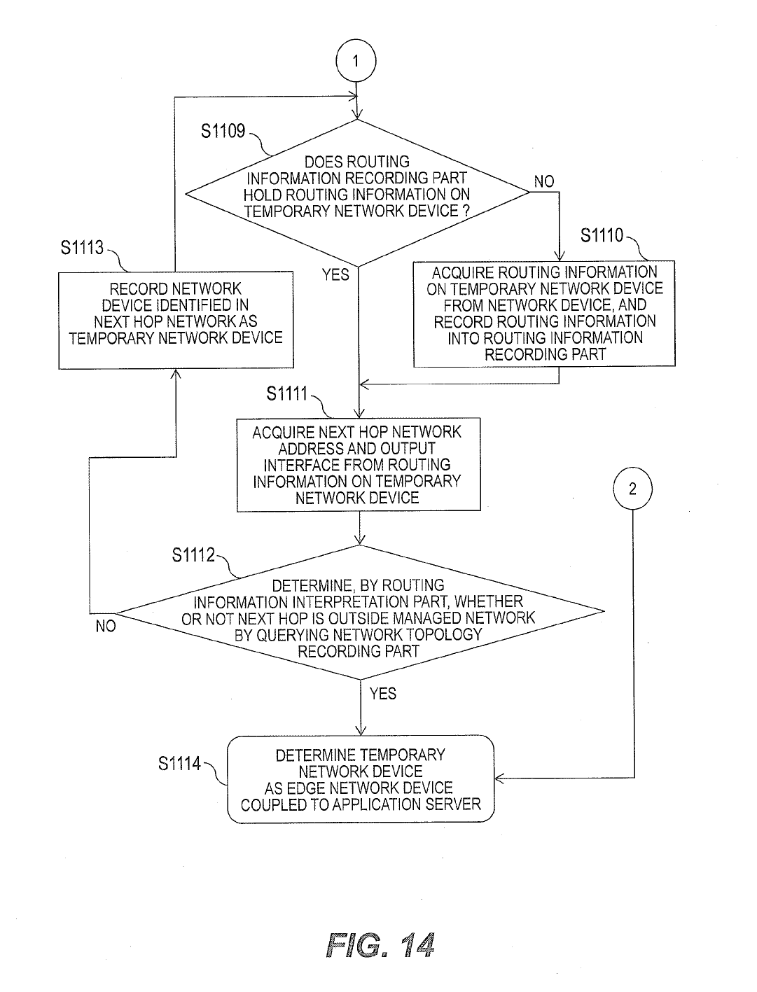

After Step S1001, by the processing illustrated in FIG. 13 and FIG. 14, the information acquiring agent 217 identifies the server-side edge network device corresponding to the network address indicated by the information acquisition request based on the network topology recording part 215 or the like (S1002).

FIG. 13 is a flowchart illustrating a first half of processing for identifying a server-side edge network device according to the first embodiment.

Now, a description is made of processing performed until a server-side edge network device 220Y corresponding to a network address X indicated by the information acquisition request is obtained.

The agent request processing part 2171 receives the information acquisition request and the application edge device list (S1100). After Step S1100, the agent request processing part 2171 determines whether or not the entry indicating the edge network device 220 corresponding to the network address X is included in the address-edge device recording part 2178 (S1101).

It should be noted that the address-edge device recording part 2178 in Step S1101 may be updated to the latest state by the above-mentioned processing of the output edge information generation part 2175 and the network topology recording part 215 updated in Step S1001.

Specifically, the agent request processing part 2171 determines whether or not the entry having the destination network 21753 indicating the network address X is included in the address-edge device recording part 2178. When the entry having the destination network 21753 indicating the network address X is included in the address-edge device recording part 2178, the agent request processing part 2171 extracts the entry having the destination network 21753 indicating the network address X. Then, the agent request processing part 2171 stores the identifier of the edge network device 21751 of the extracted entry into the memory included in the information acquiring agent 217 as the identifier of a temporary network device (S1102).

The temporary network device of FIG. 13 and FIG. 14 is a candidate for the server-side edge network device.

When the entry having the destination network 21753 indicating the network address X is not included in the address-edge device recording part 2178, the agent request processing part 2171 transmits the network address X to the routing information interpretation part 2172 (S1103).

When receiving the network address X, the routing information interpretation part 2172 determines whether or not the routing information recording part 2174 includes the routing information relating to the network address X. When the network address X is stored into any one of the destination network addresses 21742, the routing information interpretation part 2172 determines that the routing information recording part 2174 includes the routing information relating to the network address X (S1104).

When it is determined that the routing information recording part 2174 includes the routing information relating to the network address X, the routing information interpretation part 2172 extracts the routing information relating to the network address X from the routing information recording part 2174.

Then, the routing information interpretation part 2172 acquires the information of the next hop network address 21743 and the network device 21741 from the extracted routing information. For example, in the example shown in FIG. 10, when the network address X is “192.0.2.192/28”, the routing information interpretation part 2172 acquires “NE1” as the identifier of the network device 21741, and acquires “192.51.100.65/28” as the value of the next hop network address 21743.

Then, the routing information interpretation part 2172 stores the identifier of the network device acquired from the routing information into the memory included in the information acquiring agent 217 as the identifier of the temporary network device (S1108).

When it is determined in Step S1104 that the routing information recording part 2174 does not include the routing information relating to the network address X, the routing information interpretation part 2172 selects one edge network device 220 or one network device 221 for which the routing information is not held in the routing information recording part 2174, and acquires the routing information from the selected network device 22 (S1105).

Specifically, in Step S1105, the routing information interpretation part 2172 acquires the identifiers of all the network devices 22 included in the communication network 20 from the network topology recording part 215, and extracts the identifier that is not stored in the routing information recording part 2174 from among the acquired identifiers. Then, the routing information interpretation part 2172 selects one identifier from among the extracted identifiers, and acquires the routing information from the network device 22 of the selected identifier through the network device coupling interface 216.

Then, the routing information interpretation part 2172 determines whether or not the acquired routing information indicates the network address X as a destination network address (S1106). When the network address X is not indicated as a destination network address, the routing information interpretation part 2172 keeps selecting the identifier from among the identifiers that are not stored in the routing information recording part 2174, and acquires the routing information from the network device of the selected identifier (S1105).

When the routing information indicating the network address X as the destination network address is acquired, the routing information interpretation part 2172 adds the acquired routing information to the routing information recording part 2174. Then, the routing information interpretation part 2172 stores the identifier of the network device 21741 of the acquired routing information into the memory included in the information acquiring agent 217 as the identifier of the temporary network device (S1107).

FIG. 14 is a flowchart illustrating a second half of the processing for identifying the server-side edge network device according to the first embodiment.

After Step S1108 or S1107, or after Step S1113 described later, the routing information interpretation part 2172 determines whether or not the routing information recording part 2174 holds the routing information acquired from the temporary network device stored in the memory (S1109).

When the routing information recording part 2174 does not hold the routing information, the routing information interpretation part 2172 acquires the routing information from the network device 22 corresponding to the temporary network device through the network device coupling interface 216. Then, the routing information interpretation part 2172 adds the acquired routing information to the routing information recording part 2174 (S1110).

When the routing information recording part 2174 holds the routing information acquired from the temporary network device or after Step S1110, the routing information interpretation part 2172 acquires the values of the next hop network address 21743 and the output interface 21744 from the routing information acquired from the temporary network device (S1111).

After Step S1111, the routing information interpretation part 2172 determines which of the address of the apparatus included in the communication network 20 and the address of the apparatus outside the communication network 20 a next hop network address is based on the network topology recording part 215, the acquired value of the output interface, and the identifier of the temporary network device (S1112).

Specifically, the routing information interpretation part 2172 extracts, from the network topology recording part 215, the entry having the network device 2151 indicating the temporary network device and having the acquired value of the output interface and the value of the interface 2152 matching each other, and determines whether or not the external network coupling 2154 of the extracted entry is “True”. When the external network coupling 2154 of the extracted entry is “True”, the routing information interpretation part 2172 determines in Step S1112 that the next hop network address of the temporary network device is the address of the apparatus outside the communication network 20.

For example, in the network topology recording part 215 shown in FIG. 7, when the identifier of the temporary network device is “NE1”, and when the value of the output interface acquired in Step S1111 is “IF3”, the external network coupling 2154 indicates “False”, and hence the temporary network device does not include the interface coupled to the device outside the communication network 20. Therefore, the routing information interpretation part 2172 determines that the next hop network address of the temporary network device is the address of the apparatus within the communication network 20.

In Step S1112, when it is determined that the next hop network address of the temporary network device is the address of the apparatus within the communication network 20, the routing information interpretation part 2172 identifies the interface to which the next hop network address is assigned, and updates the temporary network device by the identifier of the edge network device 220 or the network device 221 including the identified interface (S1113).

After Step S1113, the routing information interpretation part 2172 returns to Step S1109 to continue the processing.

In Step S1112, for example, when the identifier of the temporary network device is “NE1”, and when the value of the output interface acquired in Step S1111 is “IF1”, the routing information interpretation part 2172 determines that the next hop network address of the temporary network device is the apparatus outside the communication network 20.

When it is determined in Step S1112 that the next hop network address of the temporary network device is the apparatus outside the communication network 20, the routing information interpretation part 2172 can identify the temporary network device as the network device 22 through which the traffic addressed to the application server 12 passes last within the communication network 20.

Therefore, after Step S1102 or when it is determined in Step S1112 that the next hop network address of the temporary network device is the apparatus outside the communication network 20, the agent request processing part 2171 determines the temporary network device as the server-side edge network device 220Y corresponding to the network address X (S1114).

After Step S1114, in Step S1002, the agent request processing part 2171 generates a list (hereinafter referred to as “server coupling list”) including all the determined identifiers of the server-side edge network devices 220Y and the identifier of the application corresponding to the network address X. The processing illustrated in FIG. 13 and FIG. 14 is executed for each of all the applications indicated by the information acquisition request, and hence the server coupling list is generated for each of the applications.

After the server coupling list is generated, the agent request processing part 2171 excludes the identifier of the edge network device 220 included in the generated server coupling list from the application edge device list transferred from the request reception part 212. Then, the agent request processing part 2171 generates a client coupling list including excluded results. This aims to generate a list indicating only the client-side edge network device. The server coupling list is also generated for each of the applications indicated by the information acquisition request.

It should be noted that, in Steps S1105 and S1110 described above, the routing information interpretation part 2172 acquires the routing information from the network device 22 as necessary. Step S1002 illustrated in FIG. 12 indicates the acquisition of the routing information performed in Step S1105 or S1110.

By the processing illustrated in Step S1002, the agent request processing part 2171 can narrow down the network device 22 for which the network quality information is to be acquired by identifying the server-side edge network device and the client-side edge network device. Further, the routing information interpretation part 2172 collects the routing information from the network device 22 as necessary, and hence the network management system 21 according to the first embodiment can reduce the load on the entire network device 22.

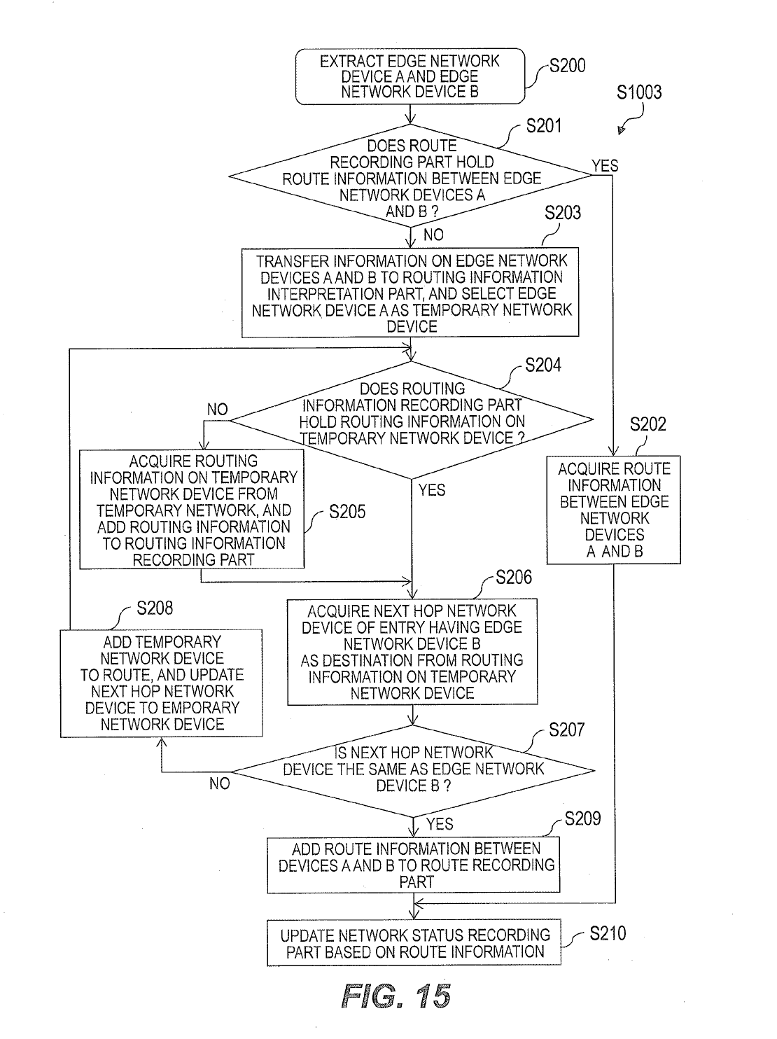

After Step S1002, the route between the client-side edge network device and the server-side edge network device on the communication network 20 is identified by the processing illustrated in FIG. 15 (S1003).

FIG. 15 is a flowchart illustrating processing for identifying, by the information acquiring agent 217, the route between two edge network devices 220 according to the first embodiment.

Then, the agent request processing part 2171 extracts the identifier of one of the edge network devices 220 corresponding to the same identifier of the application from each of the generated server coupling list and the generated client coupling list. Then, the agent request processing part 2171 defines the extracted two edge network devices 220 as an edge network device 220A and an edge network device 220B (S200).

It should be noted that, in some cases, the server-side edge network device and the client-side edge network device are the same, and the application server 12 and the client 13 are coupled to two interfaces included in one edge network device 220. In this case, the server coupling list and the application edge device (client coupling list) may include the identifier of the interfaces. Then, the agent request processing part 2171 may extract each of the identifiers of a plurality of interfaces included in one edge network device 220 as a plurality of edge network devices, to define the edge network device 220A and the edge network device 220B.

Further, the route identified by the processing starting at Step S201 is the route from the edge network device 220A to the edge network device 220B. Therefore, the agent request processing part 2171 defines the edge network device 220A and the edge network device 220B each time the processing illustrated in FIG. 15 is executed, to thereby identify the route from the server-side edge network device to the client-side edge network device and the route from the client-side edge network device to the server-side edge network device.

Further, particularly when the network quality information on the route from the application server 12 to the client 13 is acquired, the agent request processing part 2171 defines the edge network device 220A from the edge network devices 220 included in the server coupling list, and defines the edge network device 220B from the edge network devices 220 included in the client coupling list.

After Step S200, the agent request processing part 2171 determines whether or not the route recording part 2176 holds route information between the edge network device 220A and the edge network device 220B (S201). Specifically, when the route recording part 2176 includes the entry having the edge network device 21761 and the edge network device 21762 indicating the edge network device 220A and the edge network device 220B and including the route information in the route 21763, the agent request processing part 2171 determines that the route recording part 2176 holds the route information between the edge network device 220A and the edge network device 220B.

When the route recording part 2176 holds the route information between the edge network device 220A and the edge network device 220B, there is no need to further acquire the route information from the routing information recording part 2174, and hence the agent request processing part 2171 acquires the route information between the edge network device 220A and the edge network device 220B from the route recording part 2176 (S202).

When the route recording part 2176 does not hold the information relating to the route between the edge network device 220A and the edge network device 220B, the agent request processing part 2171 transfers the identifiers of the edge network device 220A and the edge network device 220B to the routing information interpretation part 2172 in order to have the routing information interpretation part 2172 identify the route. When receiving the identifiers of the edge network device 220A and the edge network device 220B, the routing information interpretation part 2172 stores the identifiers into the memory of the information acquiring agent 217 while setting the edge network device 220A as the temporary network device (S203).

In Step S203, the routing information interpretation part 2172 generates a new entry to be added to the route recording part 2176, and stores the identifier of the temporary network device (in Step S203, edge network device 220A) into the edge network device 21761 and the route 21763 of the new entry. Further, the routing information interpretation part 2172 acquires the identifier of the interface for coupling the edge network device 220A to the client 13 from the network topology recording part 215, and stores the acquired identifier of the interface into the route 21763 of the new entry in association with the identifier of the edge network device 220A.

After Step S203 or S208 described later, the routing information interpretation part 2172 determines whether or not the routing information recording part 2174 holds the routing information on the temporary network device (S204).

When the routing information recording part 2174 does not hold the routing information on the temporary network device, the routing information interpretation part 2172 requests the routing information from the edge network device 220 or the network device 221 corresponding to the temporary network device. When acquiring the requested routing information, the routing information interpretation part 2172 adds the acquired routing information to the routing information recording part 2174 (S205).

When it is determined in Step S204 that the routing information recording part 2174 holds the routing information on the temporary network device or after Step S205, the routing information interpretation part 2172 extracts the entry of the routing information recording part 2174 including the identifier of the temporary network device in the network device 21741 and including the identifier of the edge network device 220B in the destination network address 21742. Then, the routing information interpretation part 2172 acquires the value of the next hop network address 21743 and the identifier of the output interface 21744 from the extracted entry.

Here, the routing information interpretation part 2172 stores the acquired identifier of the output interface 21744 into the route 21763 of the entry generated in Step S203 in association with the identifier of the temporary network device.

In addition, the routing information interpretation part 2172 extracts the entry of the network topology recording part 215 including the acquired value of the next hop network address in the network address 2153, and acquires the identifiers of the network device 2151 and the interface 2152 from the extracted entry.

Here, the routing information interpretation part 2172 stores the acquired identifiers of the network device 2151 and the interface 2152 into the route 21763 of the entry generated in Step S203 (S206).

After Step S206, the routing information interpretation part 2172 determines whether or not the acquired identifier of the network device 2151 indicates the edge network device 220B (S207). When the acquired identifier of the network device 2151 does not indicate the edge network device 220B, in order to further identify the network device 221 included in the route, the routing information interpretation part 2172 stores the acquired identifier of the network device 2151 into the memory as the temporary network device (S208). Then, the routing information interpretation part 2172 returns to Step S204.

When the identifier of the network device 2151 acquired in Step S206 indicates the edge network device 220B, which means that all the network devices 22 included in the route have been identified, the routing information interpretation part 2172 stores the identifier of the edge network device 220B into the edge network device 21762 of the entry generated in Step S203. Further, the routing information interpretation part 2172 acquires the identifier of the interface for coupling the edge network device 220B to the application server 12 from the network topology recording part 215, and stores the acquired identifier of the interface into the route 21763 of the entry generated in Step S203 in association with the identifier of the edge network device 220B.

Then, the routing information interpretation part 2172 determines the entry to be added to the route recording part 2176 generated in Step S203 and updated in Step S206, Step S209, and the like as the route information between the edge network device 220A and the edge network device 220B.

Then, the routing information interpretation part 2172 transmits the determined route information between the edge network device 220A and the edge network device 220B to the agent request processing part 2171. The agent request processing part 2171 adds, to the route recording part 2176, the route information transmitted from the routing information interpretation part 2172 (S209).

After Step S202 or S209, the agent request processing part 2171 updates the network status recording part 2177 based on the route information acquired in Step S202 or the route information determined in Step S209 (S210).

Specifically, in Step S210, the agent request processing part 2171 extracts a combination of the identifier of the network device 22 and the identifier of the interface included in association with the network device 22, which is stored in the route 21763 of the acquired or determined route information, and stores the extracted combination into the network device 21772 and the interface 21773 of the new entry of the network status recording part 2177. Then, the identifier of the application corresponding to the edge network device 220A and the edge network device 220B (acquired from the server coupling list or the client coupling list) is stored into the application identifier 21771 of the new entry of the network status recording part 2177.

In Step S210, no values are stored into the traffic amount 21774, the available bandwidth 21775, the delay time 21776, the packet loss rate 21777, or the information acquisition time 21778 of the network status recording part 2177. In Step S210, the agent request processing part 2171 may store a predetermined frequency into the information acquisition frequency 21779.

By the above-mentioned processing of FIG. 15, the agent request processing part 2171 can use the network status recording part 2177 to identify the route including the edge network device 220, the network device 221, and the interface for which the network quality information is to be acquired in accordance with the identifier of the application. Then, the network quality information is acquired from the identified route in processing described later, and hence the agent request processing part 2171 can narrow down the network device 22 for which the network quality information is to be acquired to a minimum.

After Step S1003, the information acquiring agent 217 acquire the network quality information on each of the edge network device 220, the network device 221, and the interface of the route identified in Step S1003 from the edge network device 220 or the network device 221 (S1004).

After Step S1003, the agent request processing part 2171 extracts the values of the network device 21772 and the interface 21773 from the entry of the network status recording part 2177 including the identifier of the application indicated by the information acquisition request in the application identifier 21771. Then, the agent request processing part 2171 transfers the identifier of the application and the kind of the information indicated by the information acquisition request and the extracted values (information including the edge network device 220, the network device 221, and the interface) to the network information acquisition part 2173.

When receiving the kind of the information indicated by the information acquisition request from the agent request processing part 2171, the network information acquisition part 2173 transmits a quality information request including the identifier of the application, the kind of the information, and the identifier of the interface (included in the received information) to the network device 22 indicated by the received information. It should be noted that, when the information acquisition request does not indicate the kind of the information, the network information acquisition part 2173 may acquire a predetermined kind of the information from the memory or the like included in the information acquiring agent 217.

The network quality information is acquired in accordance with the kind of the information indicated by the information acquisition request, and hence the network information acquisition part 2173 can narrow down the information to be acquired from the network device 22.

When receiving the quality information request, the network device 22 acquires the information on communication quality of the interface indicated by the quality information request in regard to the application indicated by the quality information request in accordance with the kind indicated by the quality information request. Then, the network device 22 transmits the acquired information on the communication quality to the network information acquisition part 2173 as the network quality information.

The network information acquisition part 2173 stores the received network quality information into the network status recording part 2177. When the network status recording part 2177 is to be updated, the network information acquisition part 2173 acquires a current time, and based on the acquired current time, updates the information acquisition time 21778 of the entry storing the network quality information.

The network information acquisition part 2173 may acquire the network quality information from the network device 22 in response to the request received from the agent request processing part 2171, and may update the network status recording part 2177 based on the acquired network quality information. Further, the network information acquisition part 2173 may periodically monitor the network status recording part 2177, and may acquire the network quality information from the network device 22 when the network status recording part 2177 is updated.

Further, the network information acquisition part 2173 may transmit the quality information request to the network device 22 based on the information acquisition frequency 21779 of the network status recording part 2177, and may acquire the network quality information from the network device 22. The information acquisition frequency 21779 of the network status recording part 2177 may differ for each value of the network device 21772.

By acquiring the network quality information based on the information acquisition frequency 21779, the network information acquisition part 2173 can continuously acquire the network quality information even when network quality of the communication network 20 fluctuates in real time.

The information acquisition frequency 21779 may be changed depending on stability of the acquired network quality information, and, for example, the network device 22 that acquires more stable network quality information may be set to have a lower information acquisition frequency.

After the network status recording part 2177 is updated, the agent request processing part 2171 generates the information to be provided to the application management system 11.

Specifically, when the network status recording part 2177 is updated, the agent request processing part 2171 refers to the route recording part 2176 and the network status recording part 2177 to generate network route information indicating the route through which the traffic relating to the application indicated by the information acquisition request passes. Then, the agent request processing part 2171 provides the generated network route information to the application management system 11.

The network route information may be provided in response to the information acquisition request, or the agent request processing part 2171 may periodically refer to the network status recording part 2177 to generate the network route information and provide the generated network route information to the application management system 11.

Further, the agent request processing part 2171 refers to the route recording part 2176 and the network status recording part 2177 to generate the network quality information on the entire route. The network quality information on the entire route is obtained by a method based on the kind of the information.

The agent request processing part 2171 calculates, for example, a total sum of the delay times at the respective interfaces of the network devices arranged on the route, to thereby obtain the delay time of the entire route. Specifically, the agent request processing part 2171 obtains the total sum of the delay times 21776 of the entries of the network status recording part 2177 each having the network device 21772 indicating the network device on the route, to thereby obtain the delay time of the entire route.

Further, the agent request processing part 2171 obtains a minimum value of the available bandwidth at the respective interfaces of the network devices arranged on the route as the available bandwidth of the entire route.

By using a predetermined method based on the kind of the information to generate the information to be provided to the application management system 11, the agent request processing part 2171 can appropriately provide the application management system 11 with the network quality information.

The agent request processing part 2171 transfers, to the request reception part 212, response information indicating two edge network devices 220 through which the traffic relating to the application indicated by the information acquisition request passes and the network quality information on the route between the two edge network devices 220. The response information may indicate the edge network device 220 by an ID or the like of the edge network device 220 assigned by the application management system 11 in order to provide the user therewith, or may indicate the edge network device 220 by the address or the identifier of the edge network device 220 used in the network management system 21. The request reception part 212 transfers the response information to the application management system 11.

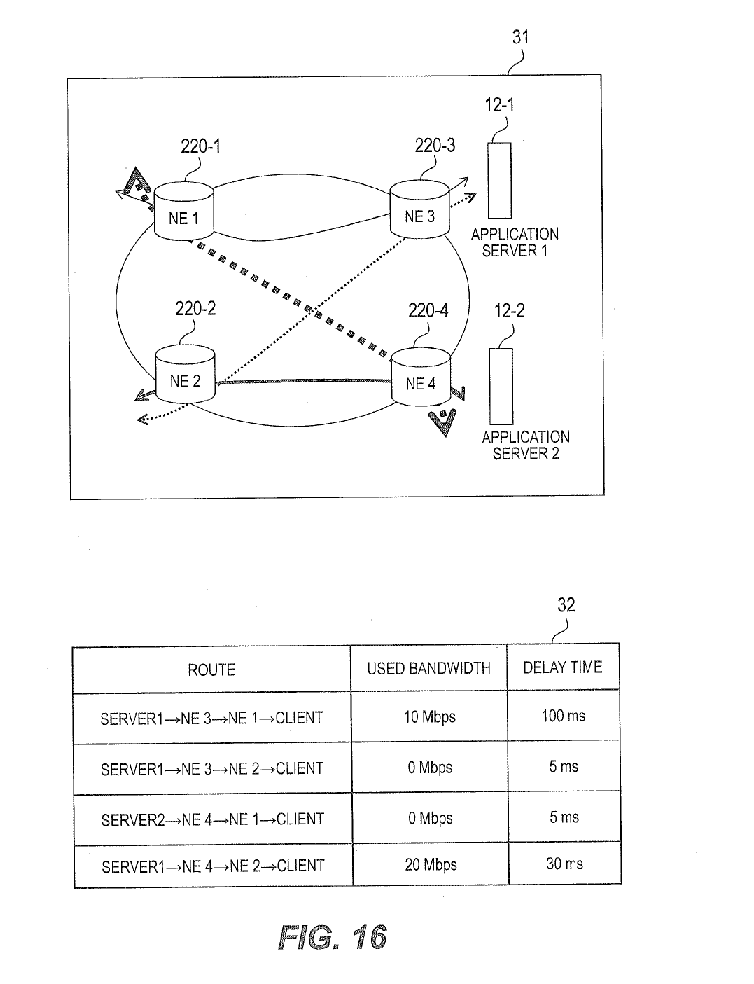

FIG. 16 is an explanatory diagram illustrating and showing an example of information provided to the user from the application management system 11 according to the first embodiment.

FIG. 16 illustrates an example of a screen generated by the output information generation part 115 based on the network route information and the network quality information provided from the network management system 21 to the application management system 11.

FIG. 16 illustrates a screen example 31 for displaying the network route information according to the first embodiment and shows a screen example 32 for displaying the network quality information according to the first embodiment.

When receiving the response information and the network route information from the network management system 21, the network information requesting part 114 updates the service status recording part 117 based on the received response information and the received network route information. Then, the output information generation part 115 provides the user with the information through the user interface 111 based on the updated service status recording part 117.

The screen example 31 illustrates an edge network device 220-3 as the server-side edge network device corresponding to the application server 12-1, and illustrates the edge network devices 220-1 and 220-2 as the client-side edge network devices. Further, the screen example 31 illustrates an edge network device 220-4 as the server-side edge network device corresponding to the application server 12-1, and illustrates the edge network devices 220-1 and 220-2 as the client-side edge network device.

The screen example 32 is generated based on the network quality information transmitted to the application management system 11 when the kind of the information indicated by the information acquisition request is the used bandwidth and the delay time.

It should be noted that, in the above-mentioned first embodiment, the output information generation part 115 visualizes the information of the service status recording part 117, but the information to be provided to the application management system 11 may be data visualized as in FIG. 16 or may be text-based data.

Further, the network management system 21 may have a function of visualizing the information as in FIG. 16. In this case, the network information requesting part 114 may transfer the received response information and the received network route information to the output information generation part 115 as it is, and the output information generation part 115 may display the received information through the user interface 111.

When the service status recording part 117 is updated, the application control part 116 of the application management system 11 may control the application server 12 in accordance with the updated service status recording part 117. A specific control procedure is described below by taking an exemplary case where the information provided to the application management system 11 is the information of the service status recording part 117 shown in FIG. 3.

The service status recording part 117 shown in FIG. 3 indicates that the application is provided from the application server 12-1 coupled to NE3 (corresponding to the edge network device 220-3) to the client 13 coupled to NE1 (corresponding to the edge network device 220-1). Further, the service status recording part 117 shown in FIG. 3 indicates that the delay time is 100 milliseconds on the route between NE1 and NE3, while indicating that the delay time is 5 milliseconds on the route between NE1 and NE4 (edge network device 220-4). It is assumed that NE4 is coupled to the application server 12-2.

Therefore, when the application server 12-1 for providing the application to the client 13 coupled to NE1 is switched to the application server 12-2 coupled to NE4, the delay time for providing the application to the client 13 can be suppressed to 5 milliseconds. Therefore, by notifying the application server 12-1 and the application server 12-2 of such switching from the application server 12-1 to the application server 12-2, the application control part 116 can switch a provision source for providing the application to the client 13 to improve quality of the application.

The application management system 11 may execute the above-mentioned control processing when being provided with the response information or the like by the network management system 21, or may execute the above-mentioned control processing after being provided with the response information or the like, for example, when there is an input of an instruction or the like received from the user.

Further, the control processing for the application server 12 performed by the application management system 11 is not limited to the switching processing for the application server 12 for providing the application, and when, for example, the application relates to video content distribution, may be processing for controlling the application server 12 to change a transfer rate thereof. This embodiment does not limit the processing of the application management system 11.

The application management system 11 according to the first embodiment changes a method of providing the application from the application server 12 based on the response information and the network route information transmitted from the network management system 21, and can therefore realize optimum network quality for providing the application. Further, when the information is periodically transmitted from the network management system 21, the optimum network quality can be realized continuously.

According to the first embodiment, the network management system 21 narrows down the network device 22 for which the network quality information relating to the application is to be acquired, stepwise by the processing of Steps S1002 and S1003, based on the information acquisition request indicating the application and the application server 12 that provides the application. This allows the network management system 21 to reduce the load imposed on the network device 22 when the network quality information is acquired.

Further, the network quality information is collected for each application in the first embodiment, and hence, even when the communication network 20 provides the service class corresponding to the application, the application management system 11 can provide the user with the network quality information on each application desired by the user.

### Second Embodiment

A second embodiment assumes an architecture, such as a packet optical transport systems (POTS) service, in which the network management system 21 sets in advance the route within the communication network 20 and the set route is provided as a service. Each application belongs to any one of services provided by the network management system 21, and the traffic of the application is transferred by using the route used by the service. The network management system 21 according to the second embodiment holds the complete information on the route.

Further, the network management system 21 according to the second embodiment holds in advance rough statistical information on the interface or the like included in the network device 22. On the other hand, the network management system 21 according to the second embodiment does not hold in advance detailed information or the like indicating the application whose traffic passes through the interface in the same manner as in the first embodiment.

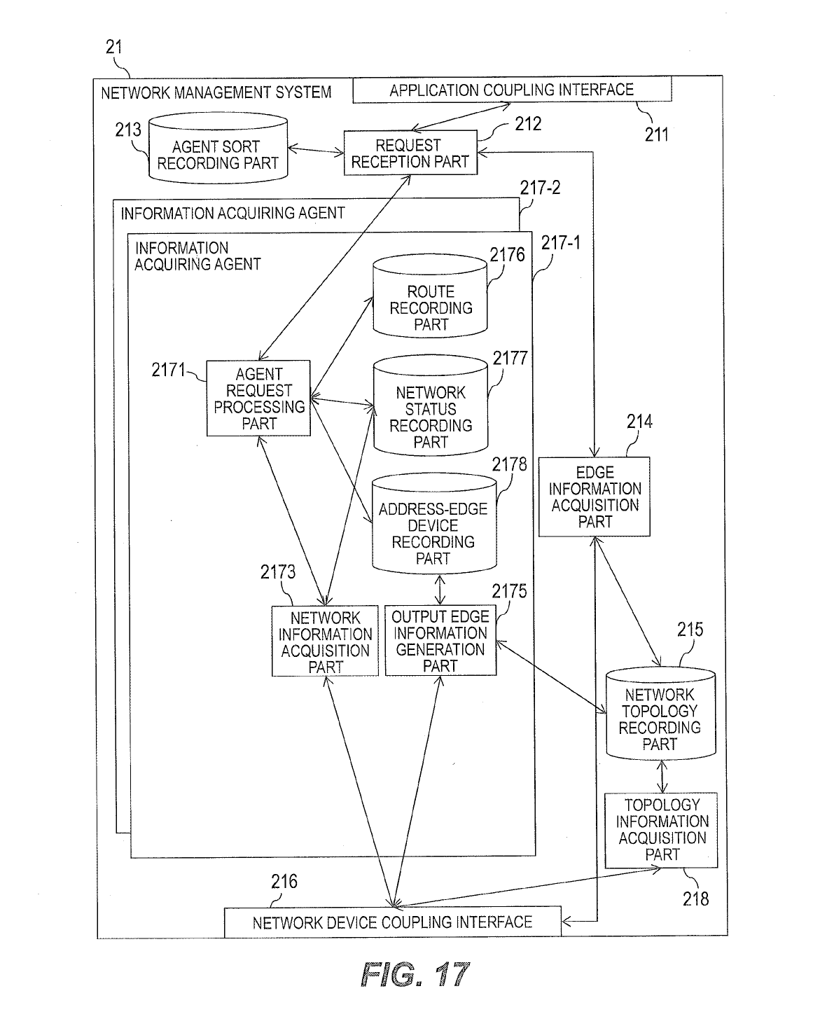

FIG. 17 is a block diagram illustrating functions of the network management system 21 according to the second embodiment.

Unlike in the first embodiment, the information acquiring agent 217 according to the second embodiment does not need to refer to the routing information recording part 2174. Therefore, the information acquiring agent 217 according to the second embodiment does not include the routing information interpretation part 2172 and the routing information recording part 2174.

On the other hand, the route recording part 2176 according to the second embodiment holds the information relating to all the routes for providing the service. Further, the route recording part 2176 according to the second embodiment includes the information on the application server 12 and the client 13 to which the network addresses are assigned and all the edge network devices 220 coupled to the application server 12 and the client 13. The first embodiment and the second embodiment differ in the above-mentioned points.

The first embodiment and the second embodiment are the same in terms of the other processing parts and recording parts.

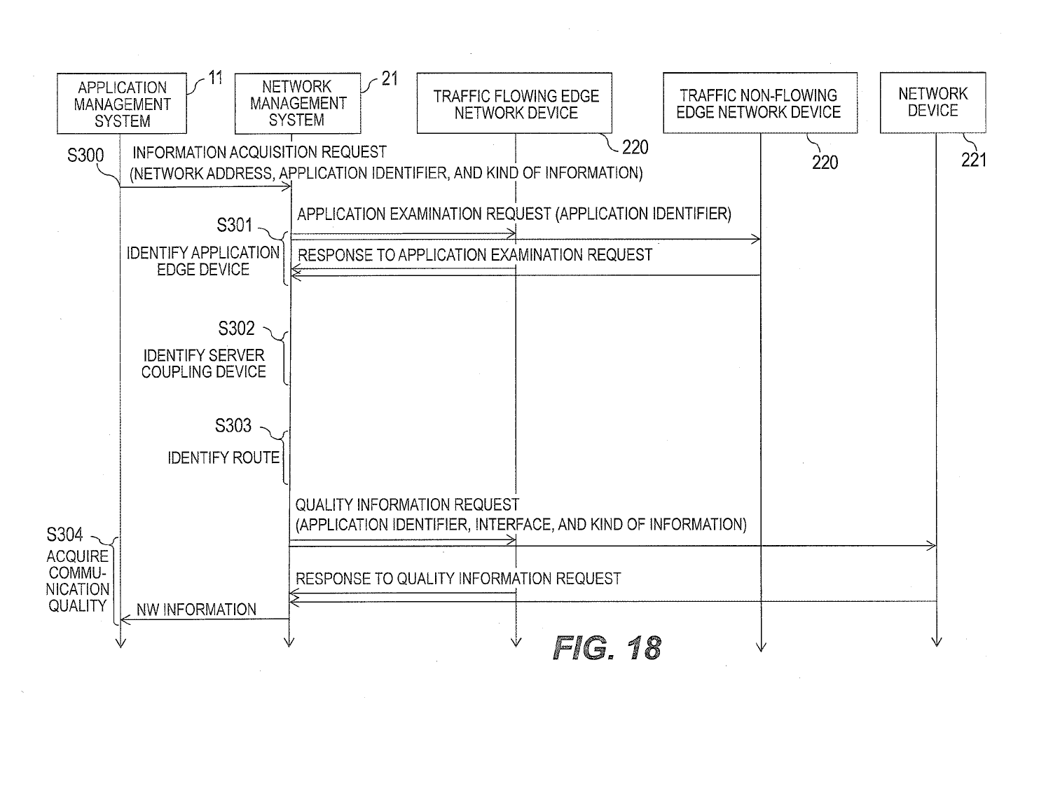

FIG. 18 is a sequence diagram illustrating processing performed among the application management system 11, the network management system 21, and the network devices 22 according to the second embodiment.

In the same manner as in the first embodiment, the network information requesting part 114 of the application management system 11 transmits the information acquisition request to the request reception part 212 of the network management system 21 (S300).

In the same manner as in Step S1001 of FIG. 12, the network management system 21 identifies the edge network device 220 through which the traffic relating to the application indicated by the information acquisition request passes, and generates the application edge device list (S301).

The network management system 21 refers to the agent sort recording part 213 to determine the information acquiring agent 217 to execute the processing corresponding to the received information acquisition request based on the application indicated by the information acquisition request. In the agent sort recording part 213 according to the second embodiment, the identifier of the application may identify the service to which the application belongs.

The request reception part 212 transfers the generated application edge device list and the received information acquisition request to the agent request processing part 2171 of the determined information acquiring agent 217.

After Step S301, the agent request processing part 2171 refers to the address-edge device recording part 2178 to identify the server-side edge network device indicated by the information acquisition request. Then, the agent request processing part 2171 generates the server coupling list including the identified edge network device 220 (S302). Contents of the server coupling list according to the second embodiment are the same as those of the server coupling list according to the first embodiment.

The address-edge device recording part 2178 according to the second embodiment always includes the identifier of the server-side edge network device corresponding to the application server 12. Therefore, in Step S302, the agent request processing part 2171 can identify the server-side edge network device without the need to acquire the routing information from the network device 22.

After Step S302, the agent request processing part 2171 according to the second embodiment generates the client coupling list by excluding the identifier of the edge network device 220 included in the server coupling list from the application edge device list. Then, the agent request processing part 2171 selects one edge network device 220 from each of the client coupling list and the server coupling list, and identifies the route between the selected two edge network devices 220 on the communication network 20 (S303).

The route recording part 2176 according to the second embodiment includes all the routes between the two edge network devices 220 for each service. Therefore, the agent request processing part 2171 according to the second embodiment does not need to acquire the routing information from the network device 22 of the communication network 20 in order to identify the route between the two edge network devices 220.

Specifically, by referring to the route recording part 2176, the agent request processing part 2171 according to the second embodiment can identify the route through which the traffic relating to the application passes, and can acquire the edge network device 220, the network device 221, and the interface through which the traffic relating to the application passes.

In Step S303, after identifying the route, in the same manner as in Step S1004 of the first embodiment, the agent request processing part 2171 according to the second embodiment acquires the network quality information and the like from the network device 22 on the route. Then, in the same manner as in the first embodiment, the acquired network quality information, the network route information, and the like are transmitted to the application management system 11.

According to the second embodiment, the network management system 21 holds coupling statuses of all the network devices 22 within the communication network 20, and hence the routing information recording part 2174 is unnecessary, which reduces the load on the processing performed by the information acquiring agent 217.

Specifically, the processing of Steps S1103 to S1113 illustrated in FIG. 13 and FIG. 14 is unnecessary, and the processing of Steps S203 to S209 illustrated in FIG. 15 is unnecessary. Therefore, compared to the first embodiment, the network management system 21 according to the second embodiment can reduce loads imposed on the network management system 21 and the network device 22.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected.

What is claimed is:

1. A network system, comprising:
a plurality of network devices;
a network management apparatus coupled to the plurality of network devices; and
an application management apparatus coupled to the network management apparatus, wherein:
the plurality of network devices comprise at least one edge network device for passing traffic therethrough one of first and last among the plurality of network devices;
the at least one edge network device is coupled to one of a provision source for providing an application by the traffic and a provision destination to be provided with the application;
the application management apparatus transmits an information acquisition request indicating the application and the provision source of the application to the network management apparatus;
the network management apparatus comprises a topology storage area indicating the at least one edge network device;
the network management apparatus is configured to:
receive the transmitted information acquisition request;
generate, based on the topology storage area, an application edge device list indicating the at least one edge network device through which the traffic for providing the application indicated by the information acquisition request passes;
identify a route through which the traffic for providing the application indicated by the information acquisition request passes, based on the generated application edge device list and the provision source of the application indicated by the information acquisition request;
acquire quality information on the identified route; and
transmit the acquired quality information to the application management apparatus.

2. The network system according to claim 1, wherein:
the network management apparatus further comprises an edge device storage area indicating a destination of the traffic passing through the at least one edge network device; and
the network management apparatus is further configured to:
determine a provision-source edge network device through which the traffic transmitted to the provision source of the application passes last and a provision-destination edge network device through which the traffic transmitted to the provision destination of the application passes last, based on the generated application edge device list, the provision source of the application indicated by the information acquisition request, and the edge device storage area; and
identify the route comprising a network device through which the traffic passes between the determined provision-source edge network device and the determined provision-destination edge network device.

3. The network system according to claim 2, wherein the network management apparatus is further configured to:
acquire the quality information on the network device comprised in the identified route;
generate the quality information on the route based on the acquired quality information and a method defined in advance in accordance with a kind of the quality information; and
transmit the generated quality information on the route to the application management apparatus.

4. The network system according to claim 3, wherein:
the information acquisition request indicates the kind of the quality information; and
the network management apparatus is further configured to acquire the quality information on the network device comprised in the route from the network device comprised in the route in accordance with the kind of the quality information indicated by the information acquisition request.

5. The network system according to claim 4, wherein:
the network management apparatus further comprises a routing information storage area for holding routing information indicating the destination of the traffic passing through each of the plurality of network devices; and
the network management apparatus is further configured to:
determine whether or not the edge device storage area indicates the at least one edge network device through which the traffic passes by using an address indicated by the information acquisition request as the destination;
extract, when the edge device storage area does not indicate the at least one edge network device through which the traffic passes by using the address indicated by the information acquisition request as the destination as a result of the determination, the network device through which the traffic passes by using the address indicated by the information acquisition request as the destination from the routing information storage area;
identify the at least one edge network device through which the traffic passes last by using the address indicated by the information acquisition request as the destination, based on the extracted network device and the topology storage area; and
determine the identified at least one edge network device as the provision-source edge network device.

6. The network system according to claim 5, wherein:
the network management apparatus is further configured to:
extract the network device through which the traffic passes by using the provision-source edge network device as the destination from the routing information storage area, to thereby extract the network device through which the traffic passes between the provision-destination edge network device and the provision-source edge network device; and
determine the route comprising the extracted network device as the route through which the traffic for providing the application indicated by the information acquisition request passes.

7. The network system according to claim 1, wherein:
the network management apparatus further comprises a sort storage area indicating the application, a service class on a network applied to the application, and a request processing part assigned to the service class; and
the network management apparatus is further configured to determine the request processing part for determining the route through which the traffic for providing the application indicated by the information acquisition request passes, based on the application indicated by the information acquisition request and the sort storage area.

8. The network system according to claim 7, wherein the application management apparatus further comprises an application control part for transmitting an instruction to change a method of providing the application to the provision source of the application based on the quality information received from the network management apparatus.

9. A network management apparatus, which is coupled to a plurality of network devices,
the plurality of network devices comprising at least one edge network device for passing traffic therethrough one of first and last among the plurality of network devices,
the at least one edge network device being coupled to one of a provision source for providing an application by the traffic and a provision destination to be provided with the application,
the network management apparatus comprising:
a topology storage area indicating the at least one edge network device;
a request reception part for receiving an information acquisition request indicating the application and the provision source of the application;
an edge information acquisition part for generating, based on the topology storage area, an application edge device list indicating the at least one edge network device through which the traffic for providing the application indicated by the information acquisition request passes;
a request processing part for identifying a route through which the traffic for providing the application indicated by the information acquisition request passes, based on the generated application edge device list and the provision source of the application indicated by the information acquisition request; and
a network information acquisition part for acquiring quality information on the identified route,
wherein the request reception part outputs the acquired quality information.

10. The network management apparatus according to claim 9, further comprising an edge device storage area indicating a destination of the traffic passing through the at least one edge network device,
wherein the request processing part is configured to:
determine a provision-source edge network device through which the traffic transmitted to the provision source of the application passes last and a provision-destination edge network device through which the traffic transmitted to the provision destination of the application passes last, based on the generated application edge device list, the provision source of the application indicated by the information acquisition request, and the edge device storage area; and
identify the route comprising a network device through which the traffic passes between the determined provision-source edge network device and the determined provision-destination edge network device.

11. The network management apparatus according to claim 10, wherein:
the network information acquisition part is configured to:
acquire the quality information on the network device comprised in the identified route; and
generate the quality information on the route based on the acquired quality information and a method defined in advance in accordance with a kind of the quality information; and
wherein the request processing part is further configured to transmit the generated quality information on the route.

12. The network management apparatus according to claim 11, wherein:
the information acquisition request indicates the kind of the quality information; and
the network information acquisition part is further configured to acquire the quality information on the network device comprised in the route from the network device comprised in the route in accordance with the kind of the quality information indicated by the information acquisition request.

13. The network management apparatus according to claim 12, wherein:
the network management apparatus further comprises a routing information storage area for holding routing information indicating the destination of the traffic passing through each of the plurality of network devices;
the request processing part is further configured to determine whether or not the edge device storage area indicates the at least one edge network device through which the traffic passes by using an address indicated by the information acquisition request as the destination;
the network management apparatus further comprises a routing information interpretation part for extracting, when the edge device storage area does not indicate the at least one edge network device through which the traffic passes by using the address indicated by the information acquisition request as the destination as a result of the determination, the network device through which the traffic passes by using the address indicated by the information acquisition request as the destination from the routing information storage area;
the routing information interpretation part identifies the at least one edge network device through which the traffic passes last by using the address indicated by the information acquisition request as the destination, based on the network device extracted by the routing information interpretation part and the topology storage area; and
the request processing part is further configured to determine the at least one edge network device identified by the routing information interpretation part as the provision-source edge network device.

14. An application management apparatus, which is coupled to a network management apparatus, comprising:
an information requesting part for transmitting an information acquisition request indicating an application and a provision source of the application to the network management apparatus; and
an output part for outputting received quality information when receiving, from the network management apparatus, the quality information acquired for a route which is identified by the network management apparatus based on the information acquisition request and through which traffic for providing the application indicated by the information acquisition request passes.

15. The application management apparatus according to claim 14, further comprising an application control part for transmitting an instruction to change a method of providing the application to the provision source of the application based on the quality information received from the network management apparatus.
